(19) United States
(12) Patent Application Publication
(10) Pub. No.: US 2018/0096623 A1
(43) Pub. Date: Apr. 5, 2018

(54) METHOD AND SYSTEM OF DRAWING GRAPHIC FIGURES AND APPLICATIONS

(71) Applicants: Tiejun J. Xia, Richardson, TX (US); Changjie Wang, Plano, TX (US)

(72) Inventors: Tiejun J. Xia, Richardson, TX (US); Changjie Wang, Plano, TX (US)

(21) Appl. No.: 15/286,040

(22) Filed: Oct. 5, 2016

(51) Int. Cl. G09B 11/00; G06F 3/0488; G06T 7/00; H04M 1/725; G09B 5/02; G09B 19/06; A63F 13/2145; A63F 13/235; A63F 13/42; A63F 13/80; A63F 13/92

(52) U.S. Cl. CPC G09B 11/00; G06F 3/04883; G06T 7/0002; H04M 1/72544; G09B 5/02; G09B 19/06; A63F 2300/8094; A63F 13/235; A63F 13/42; A63F 13/80; A63F 13/92; A63F 2300/1075; A63F 2300/6045; A63F 13/2145

(57) ABSTRACT

The present disclosure provides a method that includes displaying a first graphic figure for a period of display time Td on a touch screen device; accepting to enter a second graphic figure by the touch screen device after the first graphic figure disappears and a forbidden gap time Tf; evaluating the first and second graphic figures to determine a correlation parameter between the first and second inputs graphic figures; and displaying a result associated with the correlation parameter on the touch screen device.

This application is related to a U.S. Pat. No. 9,299,263, filed Sep. 10, 2012, entitled “Method and System of Learning Drawing Graphic Figures and Applications of Games,” the entire disclosure of which is incorporated herein by reference.

### BACKGROUND

This invention relates to a method and a system for correlating hand-drawn figures in electronic messaging system, and specifically relates to a method to help people learning drawing graphic figures more efficiently. The method can be used in fields such as education and entertainment.

Text messages or pictures are operative to be communicated among mobile devices. For example, email messages and photos are sent or received by a mobile device, such as a smart phone. However, communicating other messages, especially hand drawn figures between the mobile devices with competing and challenging factors are not developed. A method for communicating and comparing the hand drawn figures and devices enabling the method are desired.

### BRIEF DESCRIPTION OF THE DRAWINGS

The present disclosure is best understood from the following detailed description when read with the accompanying figures. It is emphasized that, in accordance with the standard practice in the industries, various features are not drawn to scale. Various features may be arbitrarily drawn for clarity of discussion. Furthermore, all features may not be shown in all drawings for simplicity.

FIG. 1 is a schematic view of a hand drawn figure system constructed according to aspects of the present disclosure in some embodiments.

FIG. 2 is a schematic view of a hand drawn figure system constructed according to aspects of the present disclosure in other embodiments.

FIG. 3 illustrates a schematic view of a touch screen device constructed according to aspects of the present disclosure in one embodiment.

FIG. 4 is a flowchart of a method constructed according to aspects of the present disclosure in one or more embodiments.

FIG. 5 illustrates time parameters in the method of FIG. 4 constructed according to aspects of the present disclosure in some embodiments.

FIG. 6 illustrates time parameters in the method of FIG. 4 constructed according to aspects of the present disclosure in other embodiments.

FIG. 7 illustrates time parameters in the method of FIG. 4 constructed according to aspects of the present disclosure in some embodiments.

FIG. 8 illustrates time parameters in the method of FIG. 4 constructed according to aspects of the present disclosure in other embodiments.

FIGS. 9A, 9B, 9C, 9D, 9E, 9F, 9G and 9H illustrate schematically various operations in the method of FIG. 4 constructed according to aspects of the present disclosure in some embodiments.

FIGS. 10A, 10B, 10C, 10D, 10E, 10F, 10G and 10H illustrate schematically various operations in the method of FIG. 4 constructed according to aspects of the present disclosure in some other embodiments.

FIG. 11 is a schematic view of a hand drawn figure system constructed according to aspects of the present disclosure in some embodiments.

FIG. 12 is a flowchart of a method constructed according to aspects of the present disclosure in some embodiments.

FIG. 13 is a schematic view of a learning method constructed according to aspects of the present disclosure in some embodiments.

FIGS. 14A, 14B, 14C, 14D, 14E, 14F, 14G, 14H and 14I illustrate schematically various operations in the method of FIG. 4 constructed according to aspects of the present disclosure in some embodiments.

FIGS. 15A, 15B, 15C and 15D illustrate schematically various operations in the method of FIG. 4 constructed according to aspects of the present disclosure in some embodiments.

FIGS. 16A, 16B, 16C and 16D illustrate schematically various operations in the method of FIG. 4 constructed according to aspects of the present disclosure in some embodiments.

FIG. 17 is a flowchart of a learning drawing method according to aspects of the present disclosure in one embodiment.

FIG. 18 is a flowchart of a learning drawing method according to aspects of the present disclosure in one embodiment.

FIG. 19 is a schematic view of a method of learning drawing according to aspects of the present disclosure in one or more embodiments.

FIG. 20 is a flowchart of a gaming method constructed according to aspects of the present disclosure in another embodiment.

FIG. 21 is a flowchart of a method constructed according to aspects of the present disclosure in another embodiment.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In the following description, exemplary embodiments of the hand drawing method, system and its applications, including learning, competition and gaming are provided for different scenarios, such as efficiently learning drawing graphic figures, gaming involving one player, gaming involving two or more players, learning drawing and gaming using one device or two devices connected via network, graphic figures including hand drawing curves and pre-stored pictures, devices including smart phones and tablet computers, etc. In various examples, the disclosed method may be used for education, entertainment and evaluation and other suitable purposes.

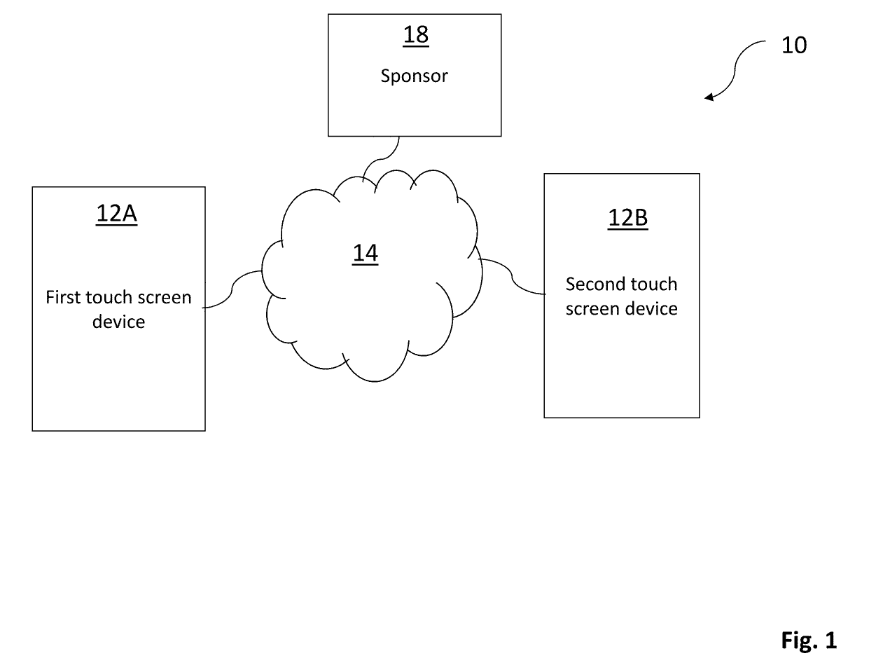

FIG. 1 is a schematic view of a hand drawn figure system 10 constructed according to aspects of the present disclosure in one or more embodiments. The system 10 illustrates general system architecture for hand drawn figure communication and processing. The system 10 and the method for hand drawn figure communication and processing to be implemented in the system 10 are described collectively with reference to FIG. 1.

The system 10 includes one or more touch screen devices 12 operable to be coupled together through a data communication network 14. A touch screen device refers to an electronic device having a touch screen to take inputs (such as hand drawing or writing on the touch screen) and is operable to communicate with other similar devices through the data communication network 14. In one example, the touch screen device 12 (such as 12A or 12B) includes a mobile phone (such as a smart phone), a tablet computer (such as an iPad), a laptop computer, a desktop computer or other proper electronic device having a touch screen. In the present embodiment for illustration, the system 10 includes two exemplary touch screen devices, respectively referred to as a first touch screen device 12A and a second touch screen device 12B.

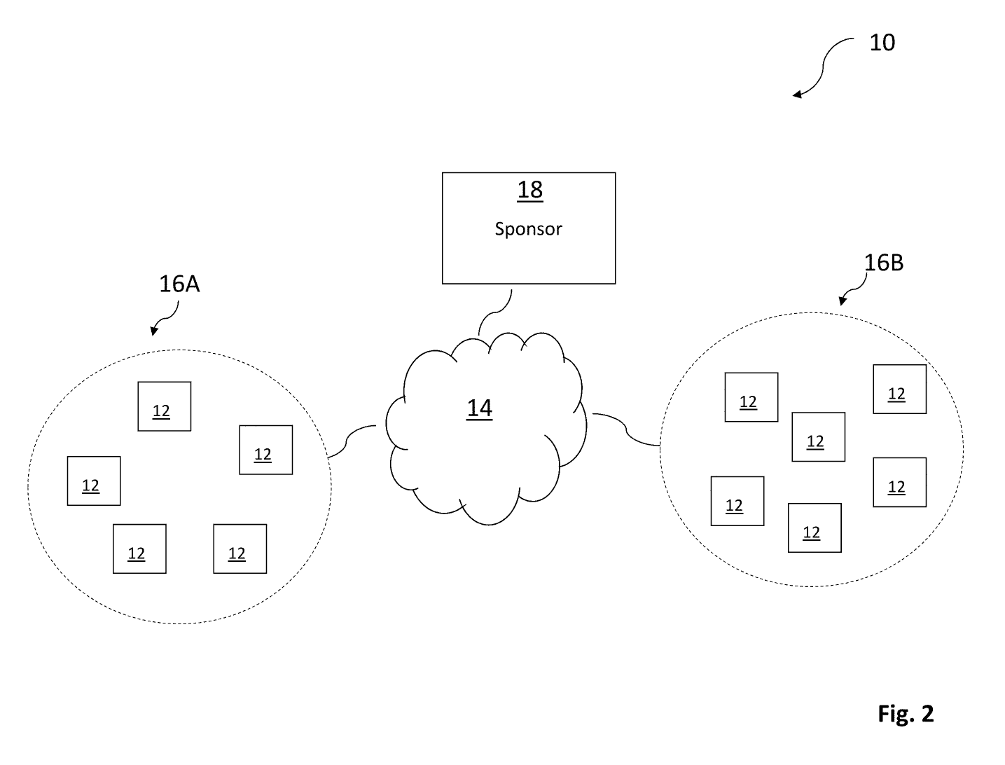

However, this is not intended to limit the scope of the present disclosure. The system 10 may include more than two touch screen devices 12 coupled through the data communication network 14. In some embodiments as illustrated in FIG. 2, the system 10 includes a plurality of touch screen devices 12 that has a first subset in a first group 16A and a second subset in a second group 16B in applications, such as a gaming or learning process. The first group 16A includes a first number (N1) of touch-screen devices 12 and the second group 16A includes a second number (N2) of touch-screen devices 12. The numbers N1 and N2 may be a same or different in various examples. In some examples, the numbers N1 and N2 are dynamic through various procedures. For examples, the players are regrouped and accordingly, the corresponding touch-screen devices 12 are regrouped. In another example, some players drop out and/or some new players join the application. Accordingly, the parameters N1 and N2 may change through the application, such as various methods to be described later. In some embodiments, the first group 16A includes one touch-screen device associated with a teacher and the second group 16B includes a plurality of touch-screen devices associated with a plurality of students for learning to draw. In some embodiments, the first group 16A includes a plurality of touch-screen devices associated with a plurality of teachers and the second group 16B includes a touch-screen device associated with a student for learning to draw. In yet some embodiments, the first group 16A includes N1 touch-screen device associated with N1 players in a first team and the second group 16B includes a plurality of touch-screen devices associated with N2 players in a second team for competition or gaming. In furtherance of the embodiments, N1 and N2 are equal and are greater than 1. In other embodiments, there is only one player. In this case, N1 is 1 and N2 is 0. In this case, the one player may learn to draw through predefined drawings in a database in the corresponding touch screen device or a database (such as a database from a sponsor) coupled through the data communication network 14. Various embodiments will be further described later with the disclosed method.

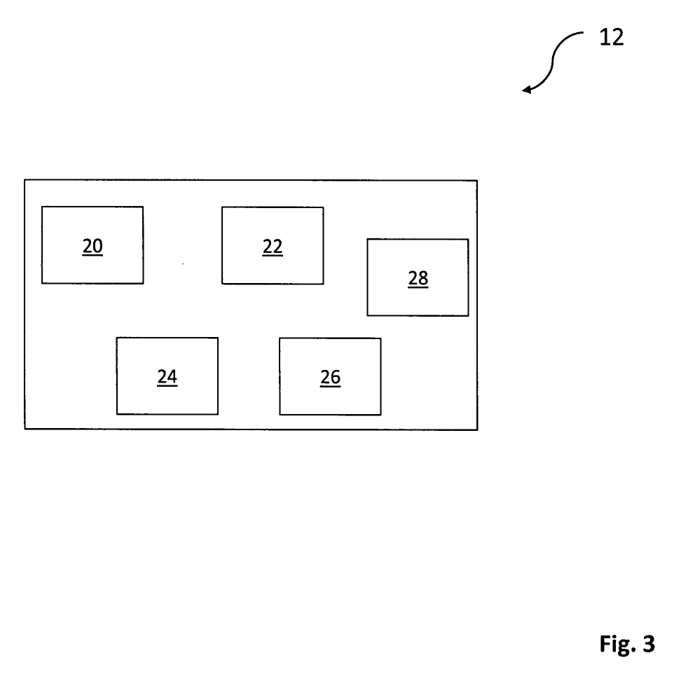

Further illustrated in FIG. 3 is a block view of the touch screen device 12 constructed according to some embodiments. The touch screen device 12 includes a transmission module 20 operable to receive data (such as a first hand-drawn figure) from another touch-screen device through the data transmission network 14.

The touch screen device 12 includes a touch screen 22 operable to receive an input, such as a second hand-drawn figure entered by a user (user or player exchangeable in the following descriptions) by touching the touch screen 22 and writing/drawing on the screen. In some embodiments, the touch screen 22 includes a sensing unit and a sensing controller integrated together. The sensing unit is capable of sensing finger positions and the sensing controller is capable of processing and interpreting the finger positions, such as hand written letters or a hand drawn figure. In some examples, the sensing unit includes a plurality of sensor cells configured in an array and designed to sense finger touch through a mechanism, such as capacitive coupling.

Even though the entity 22 is referred to as touch screen, it is not intended to limit. The touch screen 22 is a module capable of sensing inputs, such as finger events (writing or drawing by one or more finger). Those finger events can be in a touching mode (the finger directly touches the screen) or alternatively in a remote mode (the finger has no direct contact with the screen but in a remote location such that the finger events can be properly sensed and interpreted. Furthermore, it is not necessarily associated with a finger or a hand. The events to be sensed could be applied by a stylus or other human body parts, such as a foot or an eye. For example, the touch screen 22 is capable of sensing eye motions as input. In this case, the eye motions are sensed in a remote mode. In further alternative embodiments, a touch screen device is extended to other suitable device that is operable to detect and record the motions of a stylus, a hand, a finger or other human body parts either in direct-contact mode or non-contact mode (close but no direct contact to the corresponding device).

The touch screen device 12 also includes a data processing module 24 operable for processing various data (and various actions) that include operating, normalizing, mapping, comparing, evaluating, interpreting, translating and/or correlating data, such as a letter, a word, or a figure. In a particular example, the data includes the first hand-drawn figure and the second hand-drawn figure. The data processing module 24 further includes a mechanism to generate a correlation parameter based on various data and processing result. For examples, the correlation parameter is generated according to a difference between the first hand drawn figure and the second hand drawn figure. In some embodiments, normalizing a figure includes shifting and resizing of the figure. In some embodiments, evaluating a figure includes determining a complexity level of the figure.

The touch screen device 12 further includes a display module 26 that is capable of displaying an object (such as a figure or a text) on the touch screen device for predefined time duration. In some embodiments, the display module 26 includes a display controller and a display screen coupled or integrated together. The display controller controls the displaying of the object on the display screen. In some embodiments, the display screen and the touch screen 22 share a same screen that is operable of sensing and displaying.

The touch screen device 12 further includes a timing module 28 operable to receive, maintain, and manage various times to be implemented in the disclosed method. The timing module 28 includes hardware (such as an integrated circuit) and software (such as an algorithm). For example, the displayer screen displays the object for a period of time. The period of time is provided by the timing module 28 to the display module 26 such that the object is displayed only for the period of time and disappears from the display screen thereafter. In some embodiments, the timing module 28 is also operable to receive, maintain, and manage other time parameter, such as forbidden gap time and drawing times, which will be described at later stages.

The touch screen device 12 may include other modules. Various modules may be configured, distributed, integrated and coupled differently according to various embodiments. In some embodiments, as noted above, the touch screen 22 and the display module 26 share a common screen for both displaying and sensing. Various modules of the touch screen device 12 are integrated to be functional to implement various operations of the disclosed method.

In the above descriptions, the figure to be entered, received, displayed and processed by the touch screen device 10 includes any hand-drawn figure, such as a readable symbol, a picture, or combinations thereof. In one embodiment, the readable symbol includes one of a letter, a number, a character, and combinations thereof. In another embodiment, the picture includes a curved line, a straight line, a colored line, a drawing, or combinations thereof. Again, a hand drawn figure may be drawn by a stylus, a finger, or any human body part.

Touch screen (such as cellular phones, tablet computers, instruments, etc.) provides effective approaches for the electronic devices to accept input from human-beings and to display contents to human-beings. The disclosed system and method are associated with one or more touch screen device. However, it is not limited to the touch screen device and may be extended to other devices that are operable to receive hand drawn input with or without directly contacting the device. For example, a device that is capable of receiving a hand drawing by remotely sensing hand/finger motions may be incorporated in the disclosed method and system.

Referring back to FIG. 1, the data communication network 14 includes one communication mechanism selected from the Internet, wireless relay connection (used for mobile phones), intranet, WiFi connection, Bluetooth, cable connection, other suitable communication technique or a combination thereof. In one example, two touch screen devices (12A and 12B) are two tablet computers coupled together through WiFi connection. In another example, two touch screen devices (12A and 12B) are two smart phones coupled together through a wireless relay connection.

Still referring to FIG. 1, the system may include a sponsor 18. In some embodiments, the sponsor 18 is an entity that provides software application to implement the disclosed method, update, maintain and control the use of the software application. The sponsor 18 may be a terminal coupled with the touch screen devices 12 through the data communication network 14. In some embodiments, the sponsor 18 includes hardware, software and database integrated together to implement its intended functions. The sponsor 18 may be distributed in different locations, or embedded in various systems.

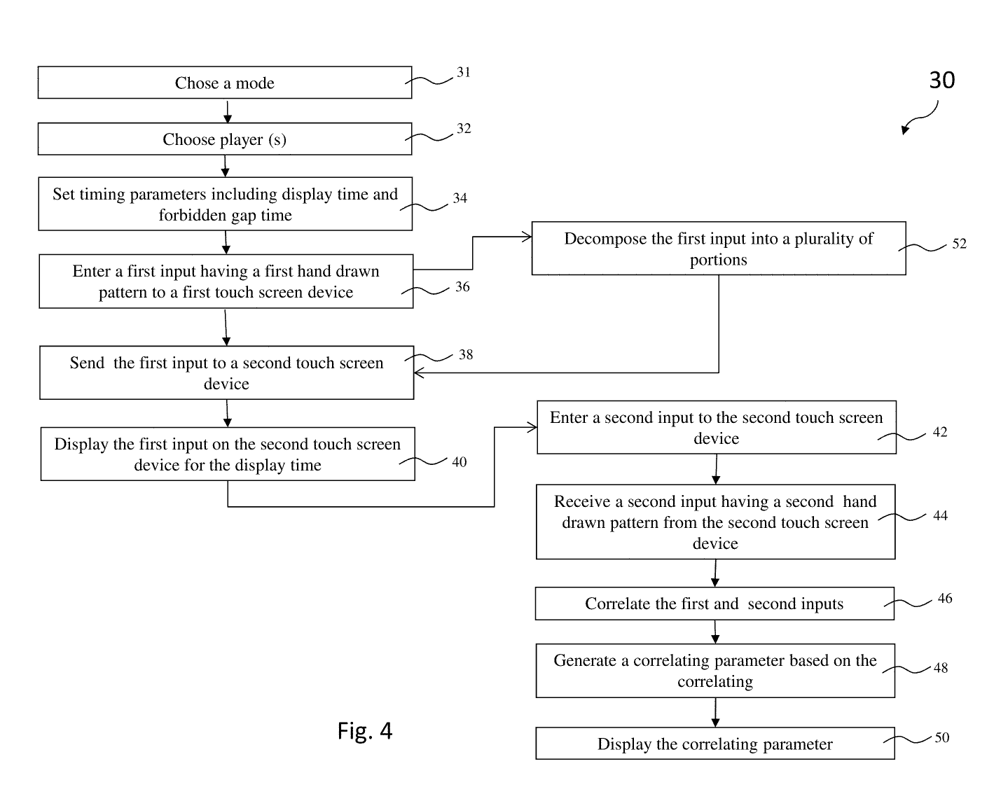

FIG. 4 is a flowchart of a method 30 constructed according to aspects of the present disclosure in one or more embodiments. The method 30 is implementable in the hand drawn figure system 10 of FIG. 1 or FIG. 2. The method 30 is described with reference to FIGS. 1 through 4.

The method 30 may begin at an operation 31 by choosing a play mode. The operation 31 is executed by a first user using the first touch screen device 12A. In some embodiments, the modes include a learning mode and a completion mode. For example, in the learning mode, the first user may play as a tutor, one of tutors, a student or one of students. In another example, in the learning mode, the method 30 is designed for learning to draw; to write a letter; to spell a word; write a text; or to translate (from an object to a text; from a text to an object; or from a language to another language). In another example, the competition mode includes two or more players compete with each other. The modes to choose from may include other modes, such as team competition (a group to a group); or a class (a teacher to a plurality of students).

The method 30 may include an operation 32 by choosing another player or other players according to the determined play mode. For example, when a class mode is chosen, a list of students in the class may be shown on the display screen for the first user to choose from. In another example, the first user directly enters a second player to the touch screen, in the competition mode.

The method 30 includes an operation 34 to initiate various settings that include setting a display time and a forbidden gap time. In various embodiments, the parameters set by the operation 34 may include display time, forbidden gap time, first drawing time, second drawing time, or a combination thereof. Those timing parameters and corresponding definitions will be further described later. In the present embodiment, the display time, drawing times and forbidden gap time are set to be fixed period of times, respectively. In other embodiments, those timing parameters may be reset after each learning (competition) cycle in the method 30.

In some embodiments, the setting operation 34 is performed by a first user who uses the first touch screen device 12A. In some other embodiments, the operation 34 is achieved by multiple users through a setting procedure. In the setting procedure, the multiple users input respective values of a parameter through respective touch-screen devices; and then those values are combined (such as by averaging) to determine the final value of that parameter. In a particular example, the setting is jointly implemented by the first user and the second user. For example, the first and second users each pick a values, the method 30 automatically (by algorithm) chose a value most close to both picked values, such as with least variation.

In some embodiments, various settings in the operation 34 are automatically (by algorithm) determined by the system 10 or a component thereof, such as the first touch screen device 12A. In some embodiments, the timing parameters are determined according to other parameters, such as difficult level, user level, previous ranking/score, application characteristics, or a combination thereof.

In some embodiments, the operation 34 includes choosing a difficult level (such as selecting one from a list of multiple difficult levels) by the first user, and one or more timing parameter (such as display time) is determined according to the chosen difficult level. For example, when the difficult level is higher, the display time is determined to be shorter to match the challenge of the chosen difficult level. In furtherance of the embodiments, the display time is automatically determined from a lookup table that pairs display times and difficult levels. The lookup table may be saved in a database, such as the database of the system 10 or the database of the touch-screen device 12A. In this case, the method system 10 automatically sets the display time according to the corresponding difficult level by searching the lookup table.

In some embodiments, the system 10 automatically choses a display time according to the rankings (higher ranking, shorter display time for increased challenge level corresponding to the ranking in one example) or previous score of a player (higher score, shorter display time in another example).

In yet other embodiments, various parameters are determined through a combination of the above mentioned mechanisms. For example, a first subset of parameters is determined by a first mechanism (such as difficult level) and a second subset of parameters is determined by a second mechanism (such as ranking).

In yet other embodiments, various parameters are determined dynamically, such as resetting in each cycle. For example, at the beginning of a first cycle, a time parameter is determined to a first value according to the ranking at that time, and at the beginning of a second cycle, is determined to a second value according to the new ranking at that time. In another example, a time parameter, at the beginning of a first cycle, is determined to a first value according in a first mechanism (such as difficult level), and at the beginning of a second cycle, is determined to a second value by a second mechanism (such as ranking).

In some other embodiments, a time parameter is determined according to multiple other parameters. For example, the display time is determined by the chosen difficult level and the complexity level of the input (the first input or the second input, which will be described later), such as being determined by a collective index Ic associated with both the difficult level D and the complexity level C of the input. In one embodiment, the collective index Ic is defined as Ic=αD+βC, in which α and β are weighting factors and α+β=1. Thus, the display time is related to the difficult level and the complexity of the input. The complexity is evaluated by the system based on the input. For example, when the first input is more complicated, the display duration is longer. When the second input is simple, the display duration is shorter. In another example, when the collective index Ic is higher or increase, the display duration is longer or increased and the forbidden gap time is shorter or decreased.

In some embodiments, various time parameters are correlated and are determined according to each another. For example, the forbidden gap time is related to the display time, the difficult level, or both. In furtherance of the example, the forbidden gap time equals to or is proportional to the display time. In some other example, the forbidden gap time is independently set by the first user, the second user or both in a way similar to set the display time. In the present embodiment, various time parameters are maintained and managed by the timing module 28 of the system 10.

In some embodiments, the operation 34 includes setting other parameters, such as the number of rounds (each round includes two cycles: the first player challenges the second player in the first cycle and the second player challenges the first player in the second cycle) that indicates how many rounds will be played. Other setting may include sound on/off, hint on/off, and/or fragmenting (decomposition: the first input is decomposed into multiple fragments to reduce the difficult) on/off. Sound effect may provide background music, for example. The hint function may provide on-screen help.

The method 30 includes an operation 36 to enter a first input that has a hand drawn figure (or hand drawn graphic figure) to the first touch screen device (such as 12A). In the present embodiment, the operation 36 is implemented after the operations 31, 32 and 34. Again, the first touch screen device may be a plurality of touch screen devices, such as the touch screen devices 16A illustrated in FIG. 2. For easy understanding, it is collectively referred to as the first touch screen device 12A in the following description. The hand drawn figure may be a symbol, a picture, a text or combinations thereof. The entering of the first input is performed by a first user in a hand drawn mode. In some embodiments, a first drawing time is defined, such as by the operation 34, as a fixed period of time. The entering of the first input is only available during the first drawing time. After the end of the first drawing time, the entering of the first input is not accepted by the system 10, which provides one way to challenge the first user. In one example, the first entering action triggers the first drawing time to tick.

The method 30 includes an operation 38 to send the first input from the first touch screen device 12A to the second touch screen device 12B through the data communication network 14. In some embodiments, the second touch screen device may be a plurality of touch screen devices, such as the touch screen devices 16A illustrated in FIG. 2. The operation 38 may be triggered by pressing a button of the first touch screen device 12A, touching a symbol on the touch screen of the first touch screen device 12, or other proper action applicable to the first touch screen device 12A. In the present embodiment, the operation 38 is executed by the first user.

The method 30 includes an operation 40 to display the first input on the second touch screen device 12B for a period of time defined as the display time. As noted above, the display time is a fixed period of time in the present embodiment. After the display time, the system 10 stops displaying the first input. The first input disappears from the display screen of the second touch screen device 12B.

The method 30 includes an operation 42 to enter a second input to the second touch screen device (such as 12B). The second input is a hand drawn figure in the present embodiment. The hand drawn figure may be a symbol, a picture, a text or combinations thereof. The entering of the second input is performed by a second user.

Once the first input is received by the second touch screen device 12B, the first input is displayed in the display screen of the second touch screen device 12B for a predefined duration (such as n second, where n is any proper value), which is defined by the display time. The second user enters the second input based on the first input and sends the second input to the first touch screen device 12A through the data communication network 14. However, the entering of the second input is acceptable by the second touch screen device 12B only after the forbidden gap time. After the first input disappears from the second touch screen 12B, there is a period of time. During that period of time, the second touch screen device 12B does not accept the entering of the second input. This period of time is defined by the forbidden gap time. The forbidden gap time is designed to exercise the memorization strength of the corresponding user (the second user at present step). Furthermore, the entering of the second input may further be limited to be completed during another period of time, which is defined by the second drawing time. As described above, the forbidden gap time and the second drawing time are time parameters defined by the operation 34.

In one embodiment, the second input is a mimic of the first input. For example, if the first input is a hand drawn picture, the second input is another picture hand drawn by the second user to mimic the hand drawn figure of the first input. In another embodiment, the second input is an input that is related to the hand drawn figure of the first input. For example, if the first input is a hand drawn picture (such as a picture of a tree), the second input is a symbol (such as “tree” in English or a text in other language) that interpreters the meaning or represents the hand drawn figure of the first input. In yet another embodiment, the second input is hand drawn figure that is related to the hand drawn symbol of the first input. For example, if the first input is a hand drawn or hand entered symbol (such as a word “tree” in English), the second input is another symbol (such as a text for a tree in another language) that translates the meaning of the symbol of the first input.

The method 30 includes an operation 44 to receive the second input having a second hand drawn figure by the first touch screen device 12A from the second touch screen device 12B through the data communication network 14. The operation 44 may be triggered by a second user who is accessing the second touch screen device 12B, after the completion of the operation 42.

The method 30 includes an operation 46 by correlating the first input and the second input. The correlating may be implemented by the data processing module 24 of the first touch screen device 12. In various embodiments, the correlating process may include picture processing (such as mapping); relating (such as relating a word to a picture); translating (such as translating a word or a phrase in one language to a word or phrase in another language); or a combinations thereof.

In some embodiments, the first and second inputs are both hand drawn figures, the operation 46 also includes a normalization process that normalizes the first and second hand drawn figures. The normalization process includes shifting; rotation; resizing of the first, the second or both hand drawn figures; or a combination thereof. For example, the second hand drawn figure is shifted to a new location so that to be co-centered with the first hand drawn figure. The center of a figure is defined in a way similar to the center of mass in physics. Each line of the figure is considered to have a uniform linear density, each area of the figure is considered to have a uniform area density, and the center of the figure is determined according to a similar formula, such as x=sum(mᵢxᵢ)/sum(mᵢ); and y=sum(mᵢyᵢ)/sum(mᵢ). In the above formula, x and y represent the center of a figure in a Cartesian coordinate; and mᵢ represents the mass of i^{th} segment of the figure, wherein the i^{th} segment is located at the location (xᵢ, yᵢ) or the center of the i^{th} segment is at the location (xᵢ, yᵢ). The mass of a line is measured in an arbitrary unit, such as a segment of a line with a unit length has a unit mass. In another example, the resizing process includes change one figure or both figures in size such that the sizes of the figures are same. In this case, the size is defined as the dimensions that a figure spans on X and Y directions. The rotation includes rotating the second figure such that both figures are in the same orientation. After the completion of the normalization, the two figures are able to be properly compared and correlated. In the present embodiment when the first and second inputs are both hand drawn figures, the method is a mimic, learning, competing (in a second cycle, the first and second players switch the rules) and/or memorizing process, which is different from a tracing process, and is more powerful procedure for learning. It is designed to eliminate other factors, such as shifting, size, orientation or a combination thereof, during the comparing and correlating. Thus, the results of the correlating are focused on mimic skill, learning ability and memorizing strength. The two figures are normalized, mapped, compared and correlated. In the present embodiment, the normalization, comparing and correlating and other operations are managed by the data processing module 24 of the system 10.

In some embodiments when the first input is a first text in a first language (such as English) and the second input is a second text in a second language (such as French), the correlating process may include translating the first text into a third text in the second language and comparing the second and third texts.

The method 30 also includes an operation 48 by generating a correlation parameter based on the results of the correlating process. In some embodiments, the correlation parameter represents the similarity between the second and the first inputs (such as in a learning-to-draw process). In some embodiments, the correlation parameter represents the accuracy between the second and the first inputs (such as in translating from a language to a different language, from a text to a figure, or from a figure to a text). For examples, the correlation parameter is a score that may be in a numerical scale (such as 0-100) or word scale (such as “excellent”, “good”, “above the average”, and so on). In other embodiments, the correlation parameter may additionally or alternatively include a message (such as “well done”) associated with the comparing result. For example, when the score is in a certain range, a relative text message is provided with the respective score (such as “excellent” for the score from 90 to 100, “good” for the score from 70 to 90, “above the average” for the score from 60 to 70, and so on).

In some other embodiments, the correlation parameter is a weighted parameter associated with one or more weighting factor, such as the difficult level and/or the complexity of the first input. For example, the final numerical score generated from the correlating process is further adjusted according to the difficult level.

The method 30 may also include an operation to send the correlation parameter from the first touch screen device 12 to the second touch screen device 14. In an alternative embodiment, the operations 46 and 48 are implemented in the second touch screen device 12B. In this case, the operation 44 may be eliminated. Instead, the method 30 includes another operation to receive the correlation parameter by the first touch screen device 12A from the second touch screen device 12B after the operations 46 and 48.

The method 30 also includes an operation 50 to display the correlation parameter. In the present embodiment, the correlation parameter is displayed in the display module of the first touch screen device 12A and in the display module of the second touch screen device 12B as well. In some other embodiments, the correlation parameter is saved for later use, such as being used to determine the final result when the method is a competition mode or being used to track the progress made by one player.

In the competition mode, the method 30 goes back to the operation 36 to repeat the all operations in a second cycle. However, the first and second users swap their roles in the second cycle. This will complete one round. The method 30 may repeat many rounds, which is defined as the number of rounds at the operation 32. The operation 50 may alternatively or additionally display the final scores to each player after the completion of the all rounds based on an average of scores from the all rounds.

In other embodiments, as illustrated in FIG. 4, the method 30 includes an operation 52 to decompose the first input into a plurality of portions (or segments if the first input is a figure having a plurality of line or curved features) to reduce the learning difficult for a beginner. The decomposing in the operation 52 may be implemented by the data processing module 20 before the operation 40 to display the first input. The second user only enters each portion each time and that portion may be processed in various ways in different modes, which is further described below. In a particular example, each portion is displayed, disappeared, and the entered figure corresponding to the portion is treated as a second input through the operations (such as operations 40, 42, 44, 46, 48 or a subset there) of the method 30. In one mode, when each portion is entered, only that portion is disappeared from the screen and the rest portions are still on the screen as a reference. In another mode, various portions are entered one by one similar to the first mode. However, the operations 46-50 are applied to the whole second hand input after the completion of entering each and every portion. For example, each portion is evaluated to determine its collective index according the difficult level and the complexity level of the portion. The portion also has corresponding display duration and forbidden gap time determined according to its collective index.

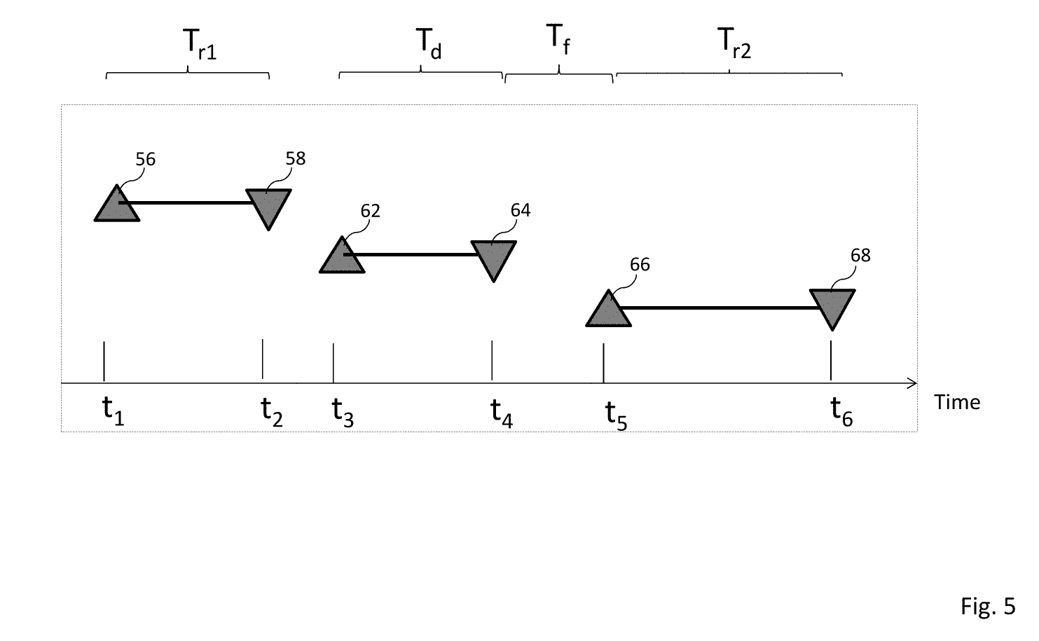

FIG. 5 illustrates schematically various time parameters of the method 30, constructed in accordance with some embodiments. The horizontal axis represents the time through the method 30. The parameter t1 represents the starting time 56 to enter the first input (as described in the operation 36); parameter t2 represents the time 58 when the system 10 stops to accept further entering of the first input; the parameter t3 represents the starting time 62 to display the first input (as described in the operation 40); parameter t4 represents the time 64 to stop displaying the first input; parameter t5 represents the starting time 66 to accept the entering of the second input (as described in the operation 42); and parameter t6 represents the time 68 to stop accepting the entering of the second input. The first drawing time Tr1 is defined as Tr1=t2−t1; the display time Td is defined as Td=t4−t3; the forbidden gap time Tf is defined as Tf=t5−t4; and the second drawing time Tr2 is defined as Tr2=t6−t5. In some embodiments, all these time parameters are fixed period of times and set at the operation 32 (by a user or the system). In some embodiments, all these time parameters may be reset, such as in different cycles of the method 30 (other cycles of the learning or competing). In some embodiments, only a subset of the time parameters is present in the method 30. In the present embodiments, various time parameters are managed and maintained by the timing module 28 of the system 10.

As noted above, the display time Td provides a first time window for the second player to review and memorize the first input, such as the first hand drawn figure. The forbidden gap time Tf provides a second time window in which the entering of the second input is not allowed or not accepted. During the forbidden gap time, the memory strength may decrease over time. This time window gives the second user a chance to practice how to memorize and maintain the memory longer, thereby enhancing memory ability. It is especially advantageous and useful for the users to train their memory ability. The drawing time Tr1 (or Tr2) provides another time window to enter the first input (or the second input). Afterward, further entering of the corresponding input (such as the first input) is not allowed or not accepted. The entering of the first input (or the second input) during the corresponding drawing time window is accepted as the first input and is not accepted beyond this time window even though it is not completed. In various embodiments, the above time window parameters may be used independently or collectively. For example, only Td and Tf are set at operation 32 without the second drawing time window. In this case, the second user may enter the second input as long as it takes and the system will accept until the second user completes the entering. In some other embodiments, the setting of the time windows may be associated with other parameters, such as the difficult level. For example, in an easy level, only the display time is set and may be set longer, or automatically defined longer by the system. In another example, in a most difficult level, all time windows are set or automatically defined by the system.

In some embodiments, the forbidden gap time Tf is eliminated. In this case, the times 64 and 66 are at a same time. This means that as soon as the first input is disappeared from the screen, the system is able to accept the entering of the second user.

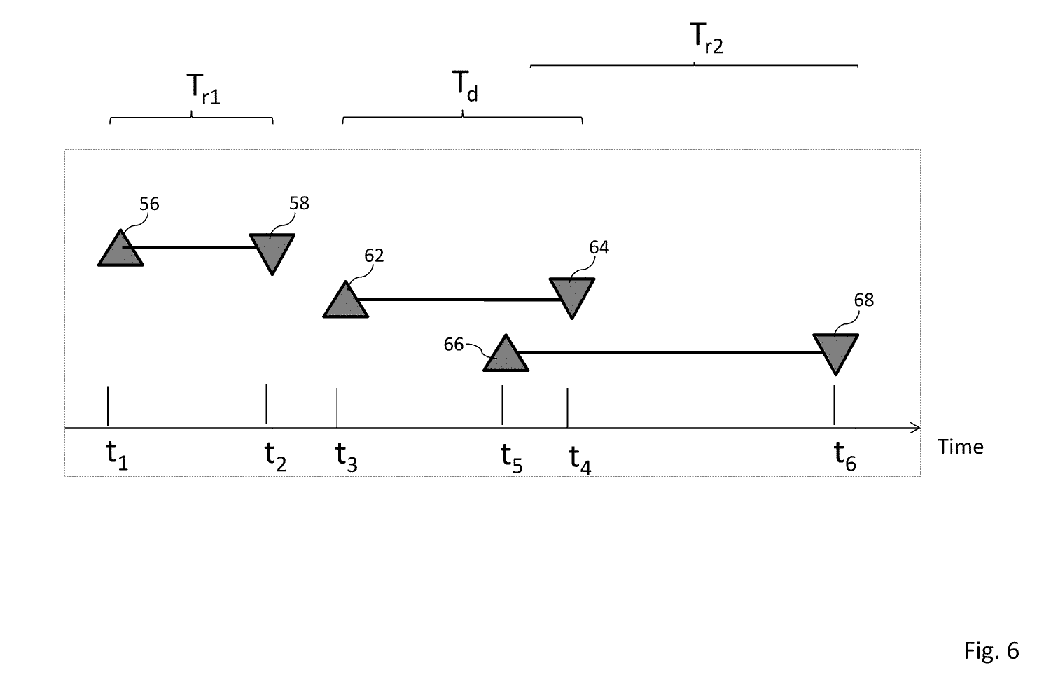

In some embodiments, as illustrated in FIG. 6, the time 66 may be set earlier than the time 64. In this case, the system 10 starts to accept the entering of the second input even before the end of the display time. The second user may start to enter the second input before the first input disappears. Thus, the display time Td and the second drawing time Tr2 are partially overlapped. This further provides freedom for a user to practice learning somewhere between the tracing and the mimic, thereby providing a transition from tracing to mimic during the learning process. So a beginner can smoothly transfer from pure tracing (Td and the second drawing time Tr2 are completely overlapped) to pure mimic (no overlap).

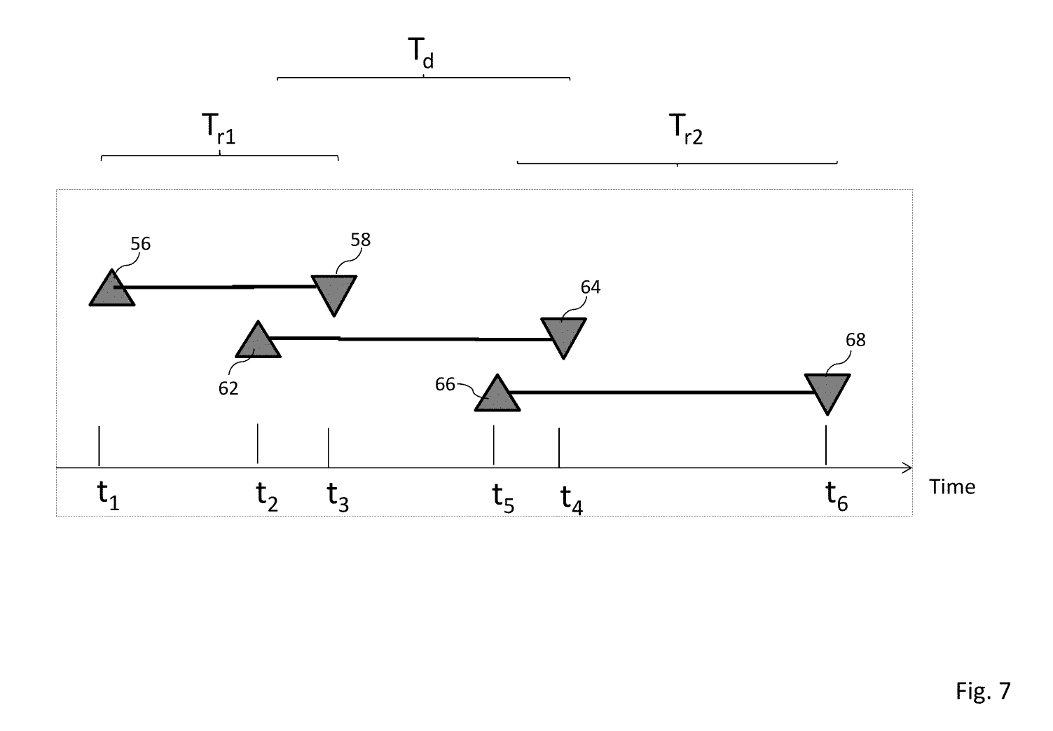

In some embodiments, as illustrated in FIG. 7, the time 62 may be set earlier than the time 58. In this case, the system 10 starts to display the first input even before the completion of the entering of the first input. For example when the first input is a graphic figure, the system dynamically sends the entered portion of the first input and displays that portion on the second touch screen device 12B. Afterward, the first user continues the entering the rest portion of the first input, and the system 10 continuously sends the newly entered portion of the first input and displays that portion on the second touch screen device 12B. This dynamic entering, sending, and displaying procedure continues until the completion of the entering of the first input by the first user. The first input may continue to be displayed on the second touch screen device until it reaches the display time Td. The display time Td may start to tick from the very beginning when only portion of the first input starts to display on the second touch screen device 12B. Alternatively, the first input is decomposed into multiple portions, each portion is sent as a package to the second touch screen device and displays on the second touch screen device with its own timer. Those portions may match the segments generated by the operation 52 or alternatively, may independently defined.

In furtherance of the embodiments, the time 66 may additionally be set earlier than the time 64, similar to that illustrated in FIG. 6. In this case, the system 10 starts to accept the entering of the second input even before the end of the display time. The second user may start to enter the second input before the first input disappears.

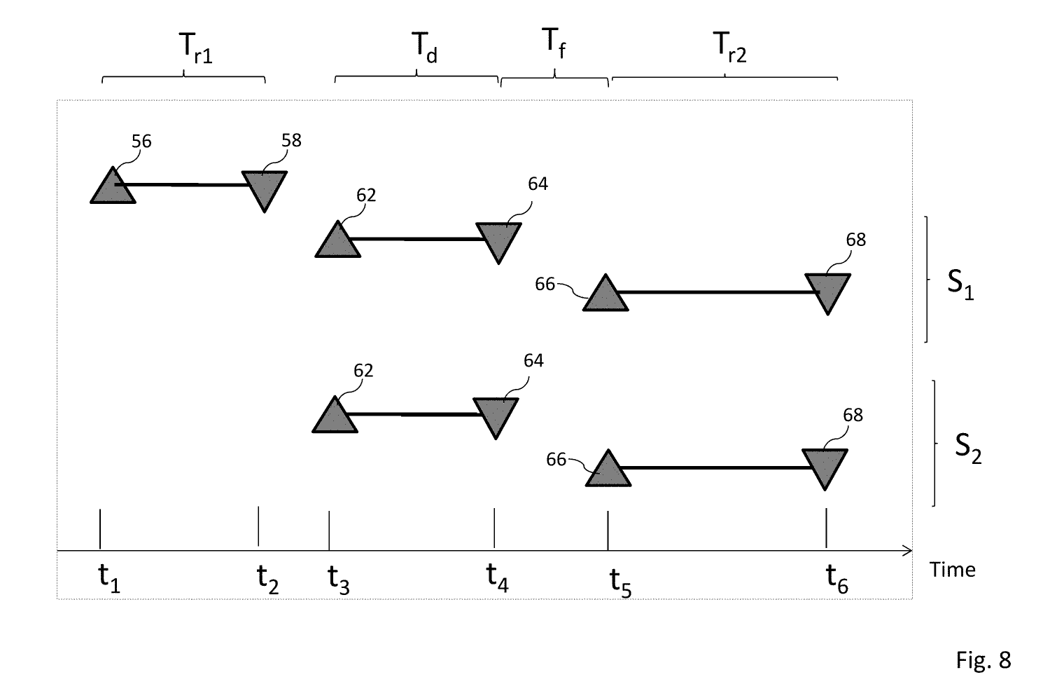

FIG. 8 illustrates various time parameters in a segmenting mode in accordance with some embodiments. In the segmenting mode, the first input may be decomposed into multiple portions by the operation 52, as described in FIG. 4. The second user only enters each portion each time and that portion may be processed in various ways in different modes, which is further described below. In a particular example, each portion is displayed, disappeared, and the entered figure corresponding to the portion is treated as a second input through the operations of the method 30. In the present example for illustration purpose, the first input includes exemplary two portions S1 and S2. The first user enters the first input and the first input is decomposed into multiple portions (two portions in the present example). The first portion S1 is displayed for a period of time defined by the display time Td. After the display time Td and the forbidden gap time Tf, the system 10 starts to accept the entering of the second input corresponding to the first portion S1 of the first input. The system will stop to accept the entering by the second user at the end of the second drawing time Tr2. Afterward, the system 10 is trigged, automatically or by the second user, to start processing the next portion (the second portion in this example) in a similar way that the first portion is processed. Particularly, the second portion S2 is displayed for a period of time defined by the display time Td. After the display time Td and the forbidden gap time Tf, the system 10 starts to accept the entering of the second input corresponding to the second portion S3 of the first input. The system will stop to accept the entering by the second user at the end of the second drawing time Tr2. For comparison, the time parameters associated with the processing of the second portion S2 is illustrated in FIG. 8 under the same time points but it is understood that the time parameters associated with the second portion are shifted. The beginning time 62 of the second portion S2 is after the end time 68 of the first portion S1. The various time parameters for each portion are illustrated in FIG. 8 without overlapping. However, in various embodiments, various time windows may be overlapped, such as those illustrated in FIG. 6 or FIG. 7. For example, the display time Td may be overlapped with the second drawing time Tr2.

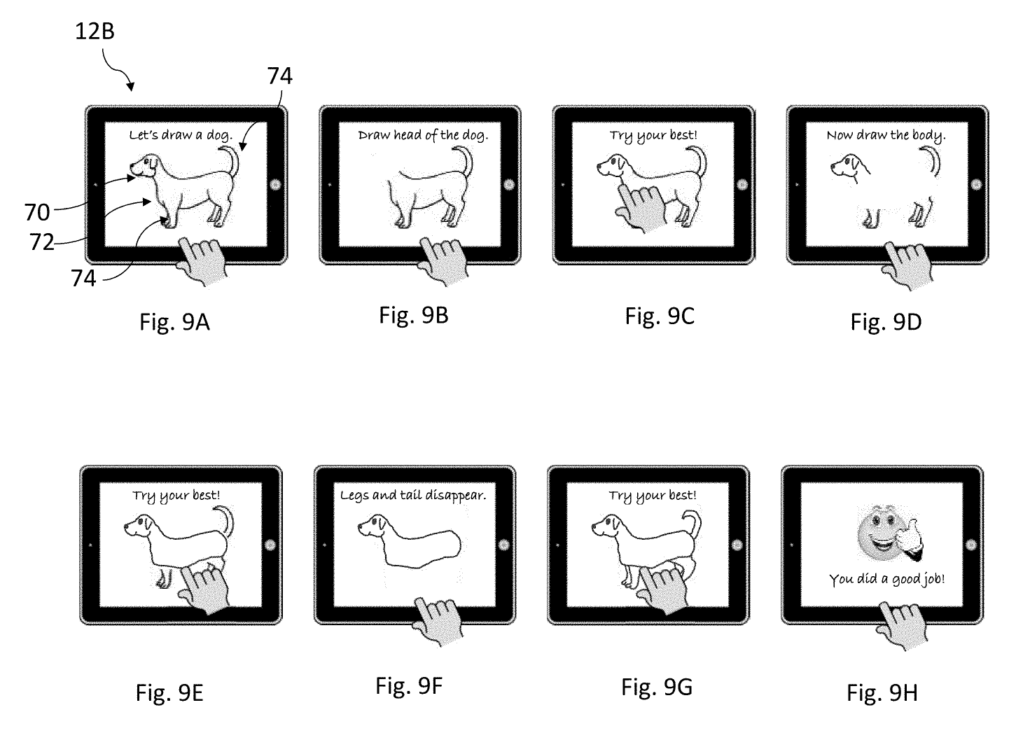

FIGS. 9A through 9H schematically illustrate a process flow of the method 30 according to some embodiments. Particularly, the process flow includes the operation 52 for decomposing the first input into a plurality of portions and thereafter processing the portions respectively. Similar operations are eliminated for simplicity. In FIG. 9A, the first input is displayed on the second touch screen device 12B for a period of time, defined by the display time Td, similar to the operation 40. Thereafter, the first input is decomposed into a plurality of portions, such as by the data processing module 24. In the present example, the first input is a hand drawn graphic figure (a hand drawn dog, in this particular example) and is decomposed into three portions, which include a first portion 70 “head”, a second portion 72 “body” and a third portion 76 “legs and tail.”

In FIG. 9B, the first portion 70 disappears from the display screen of the second touch screen device. However, the rest portions remain on the screen as a reference to provide additional help or hint to the second user.

In FIG. 9C, the first portion is entered by the second user to the second touch screen device. The entering of the first portion 70 is similar to the operation 42. For example, the forbidden gap time Tf and/or the second drawing time Tr2 may be defined and applied to the entering of the first portion 70.

In FIG. 9D, the second portion 72 disappears from the display screen of the second touch screen device. However, the rest portions remain on the screen as a reference to provide additional help or hint to the second user. In the present embodiment, as the first portion 70 has been entered by the second user and the first portion entered by the second user is displayed instead.

In FIG. 9E, the second portion 72 is entered by the second user to the second touch screen device. The entering of the second portion is similar to the operation 42. For example, the forbidden gap time Tf and/or the second drawing time Tr2 may be defined and applied to the entering of the first portion.

In FIG. 9F, the third portion 74 disappears from the display screen of the second touch screen device. However, the rest portions remain on the screen as a reference to provide additional help or hint to the second user. In the present embodiment, as the first portion 70 and the second portion 72 have been entered by the second user. Accordingly, the first and second portions entered by the second user are displayed instead.

In FIG. 9G, the third portion 74 is entered by the second user to the second touch screen device. The entering of the third portion is similar to the operation 42. For example, the forbidden gap time Tf and/or the second drawing time Tr2 may be defined and applied to the entering of the first portion.

Thus, the all three portions, collectively as the second input, have been entered by the second user. After the completion of the entering of the second input piece by piece, the method 30 proceeds to the operations 44-50. As illustrated in FIG. 9H, the final result (correlation parameter in numerical and/or text format) is displayed on the screen.

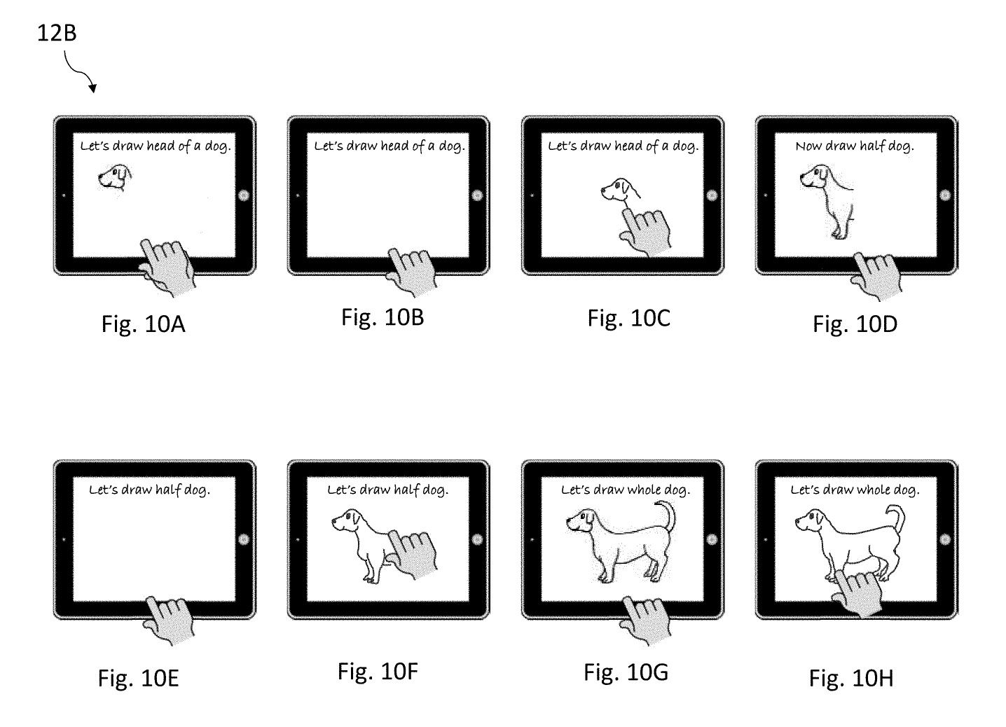

FIGS. 10A through 10H schematically illustrate a process flow of the method 30 according to some other embodiments. Particularly, the process flow includes the operation 52 for decomposing the first input into a plurality of portions and thereafter processing the portions respectively. Similar operations are eliminated for simplicity. The method in the present embodiments provides an approach different from that illustrated in FIGS. 9A through 9H. The process goes through several cycles. Each cycle is similar to the previous one but with one portion added. The first input is decomposed into a plurality of portions. In the present example, the first hand drawn figure is decomposed into three exemplary portions: left portion, middle portion and right portion, by the operation 52.

In the first cycle, only the first portion is processed (in a learning process to the second user). In FIG. 10A, the first portion is displayed on the second touch screen device 12B for a period of time defined by the display time Td, similar to the operation 40. In FIG. 10B, the first portion disappears from the display screen of the second touch screen device. In FIG. 10C, the first portion is entered by the second user to the second touch screen device. The entering of the first portion is similar to the operation 42. For example, the forbidden gap time Tf and/or the second drawing time Tr2 may be defined and applied to the entering of the first portion.

In the second cycle, the second portion is added on. Both the first and second portions are processed. In FIG. 10D, the first and second portions are displayed on the second touch screen device 12B for a period of time defined by the display time Td, similar to the operation 40. In FIG. 10E, the first portion and the second portion disappear from the display screen of the second touch screen device. In FIG. 10F, the first and second portions are entered by the second user to the second touch screen device. The entering of the first and second portions is similar to the operation 42. For example, the forbidden gap time Tf and/or the second drawing time Tr2 may be defined and applied to the entering of the first and second portions.

In the third cycle, the third portion is added on. All three portions (so the whole first hand drawn figure in the first input) are processed. In FIG. 10G, all three portions are displayed on the second touch screen device 12B for a period of time defined by the display time Td, similar to the operation 40; and then disappear from the display screen of the second touch screen device. In FIG. 10F, the all three portions are entered by the second user to the second touch screen device. The entering of the three portions is similar to the operation 42. For example, the forbidden gap time Tf and/or the second drawing time Tr2 may be defined and applied to the entering of the three portions.

In this approach, the learning process gradually increases the learning challenge. The operations 44-50 in the method 30 may be implemented to each cycle or implemented after all cycles have been completed.

In some embodiments, the first input is decomposed into portions, various portions are not only recorded with the corresponding content and but also sequential entering order (which portion is first entered in the first input, which portion is second entered, and so on) are recorded for evaluation (comparing and correlating). The second input by the second user is recorded for its content and entering order. The comparing and correlating process not only compare the similarity but also evaluate whether its entering order is correct or not. The correlation parameter is associated with both similarity and entering order. This is particularly useful in some special applications, such as learning to write Chines characters or other language characters with similar characteristics.

In various above embodiments, the first input is entered by the first user. In some other embodiments, the first input is alternatively acquired from a database that stores a plurality of examples of the first input. For example, the database includes a plurality of graphic figures as a pool for the first input. The system 10 may randomly or sequentially pick one from the pool as the first input. In this case, the operation 36 in the method 30 is replaced by an operation that includes picking one from the pool as the first input. In other example, the pool is divided into multiple groups according to one or more parameters, such as difficult level. In furtherance of the example, the selecting of the first input from the group is implemented according to corresponding parameter(s), such as selecting one from a group with corresponding difficult level according to the chosen difficult level, which is determined by the operation 34. The database may be a database in the touch screen device 12A, a database from the sponsor 18 or a remote database from Internet and coupled with the touch screen device. Accordingly, only one touch screen device, with communication with the database, is sufficient to implement the disclosed method.

In other alternative embodiments, various operations are implemented in a single touch screen device. In this case, those operations related to communicating between two touch screen devices are optional or eliminated.

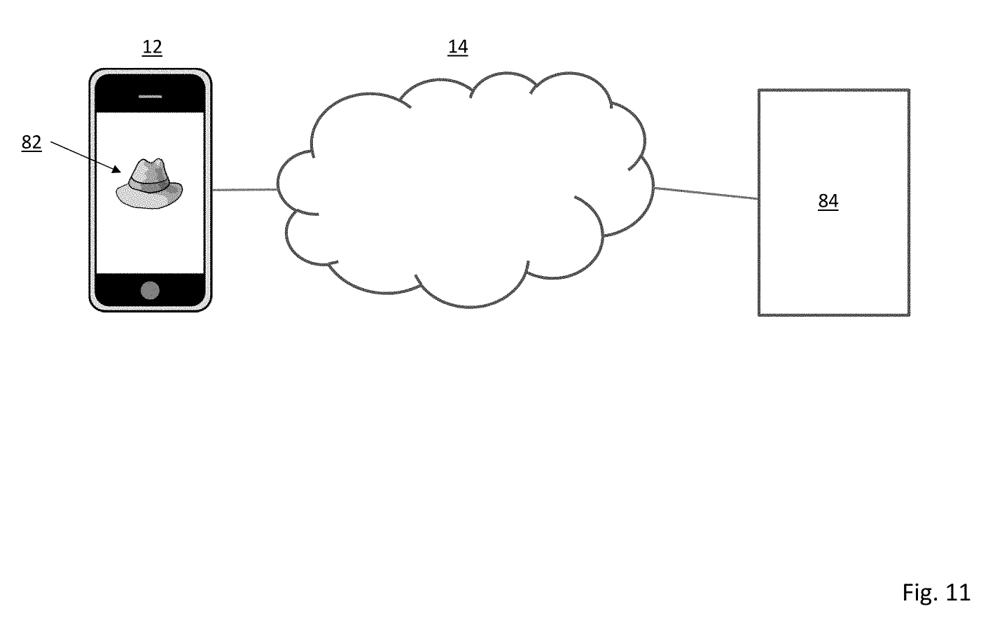

FIG. 11 schematically illustrates one example. A touch screen device 12 is able to receive the first input 82 (such as a graphic figure) from a remote database 84 via a communication network 14. The remote database 84 may be a portion of a computer, another touch screen device or other suitable subsystem having the database. With the communication network and the database 84, the touch screen device 12 is able to receive, accept and transmit an input (such as the first input in the method 30) from the communication network 14 according to various embodiments. Alternatively, the first input 82 is from a database locally in the touch screen device 12, or entered by another user through the same touch screen device 12.

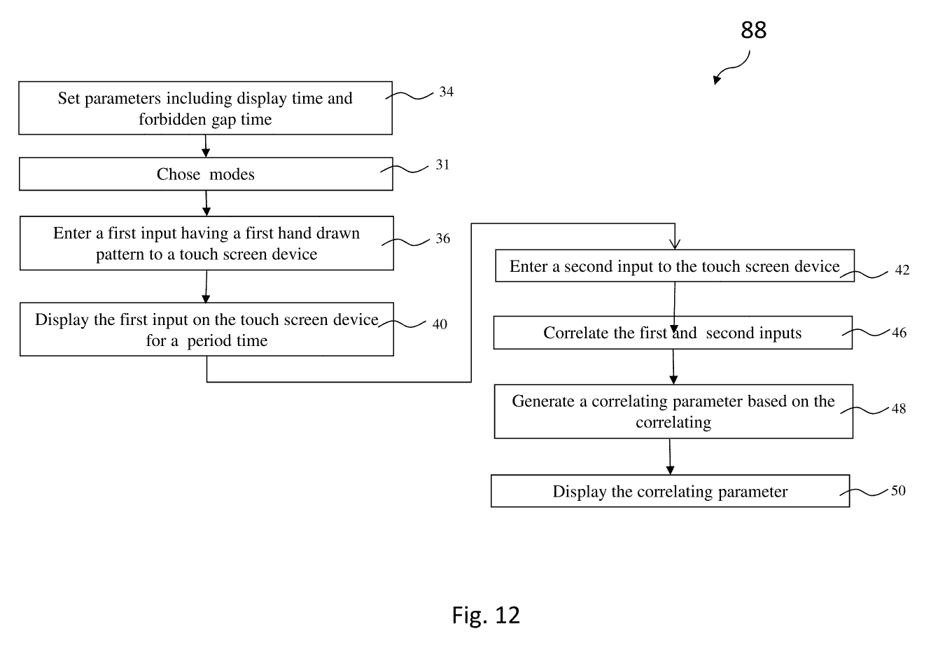

Corresponding method 88 is further illustrated in FIG. 12. Similar descriptions or equivalent features are not further described here for simplicity. Particularly, various operations, such as setting, choosing, displaying, and entering are executed in the single touch screen device 12. In some embodiments, entering the first input in operation 36 is replaced by extracting the first input from a database in a remote entity coupled with the touch screen device 12 through the communication network 14 or a database in the touch screen device 12. In the latter case, all data are processed locally in the single touch screen device 12 and all data communication to other devices and the communication network 14 is eliminated. In some embodiments, all user-involved operations may be performed by a same user. For example, the operations 34 and 31 are performed by a user who also performs the operation 42 by entering the second input. In furtherance of the embodiments, the operation 36 is replaced by extracting from a (local or remote) database.

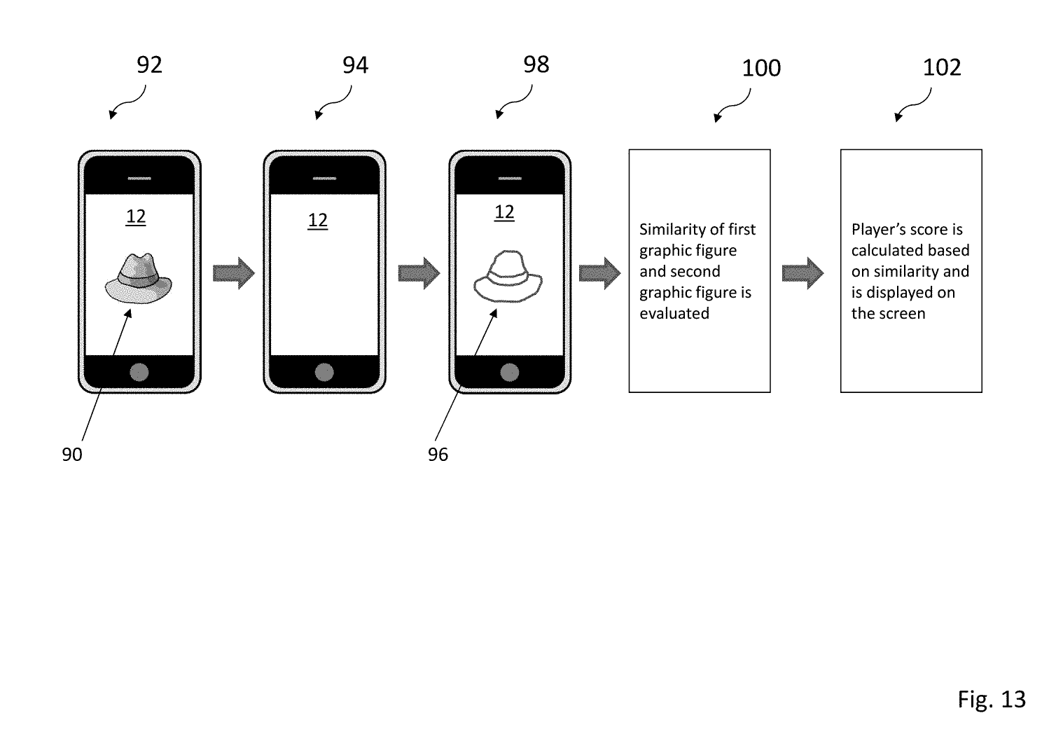

FIG. 13 illustrates an exemplary embodiment of an application of the method 30 or 88 to entertainment—a method involving one user (or a player). The user is able to learn through this method, which brings more fun and fascination to the user as a game. A first input 90 is picked (randomly, sequentially or in other mode, such as according to the difficult level) from a database and displayed on the display screen of a touch-screen device 12. In the present example, the first input 90 includes a first graphic figure. The first graphic figure is displayed on the display screen of the touch-screen device 12 for a period of time defined by the display time Td (illustrated in 92). The user looks at the first input (the first graphic figure in the present example) during the display time when the first input is displayed on the display screen and memorizes the contents of the first input. Thereafter, the first input disappears (illustrated in 94). After the first input is disappeared from the display screen or additionally after the forbidden gap time Tf, the system 10 starts to accept the entering of a second input 96 by the user (illustrated in 98) from the touch screen of the touch screen device 12. In the present example, the user tries to mimic the first input and enters the second input as similar to the first input as possible. In some embodiments, the entering of the second input is limited to a certain time as defined by the second drawing time Tr2. In this case, the system 10 stops to accept the entering of the second input after the end of the second drawing time Tr2. Thereafter, the second input is recorded for further analysis and other purposes, such as tracking the progress of the user during the learning process. A similarity between the second input and the first input is evaluated (illustrated in 100). A score is calculated based on the evaluation result (illustrated in 102). This finishes one run of the game. The number of runs in a game can be set by the user.

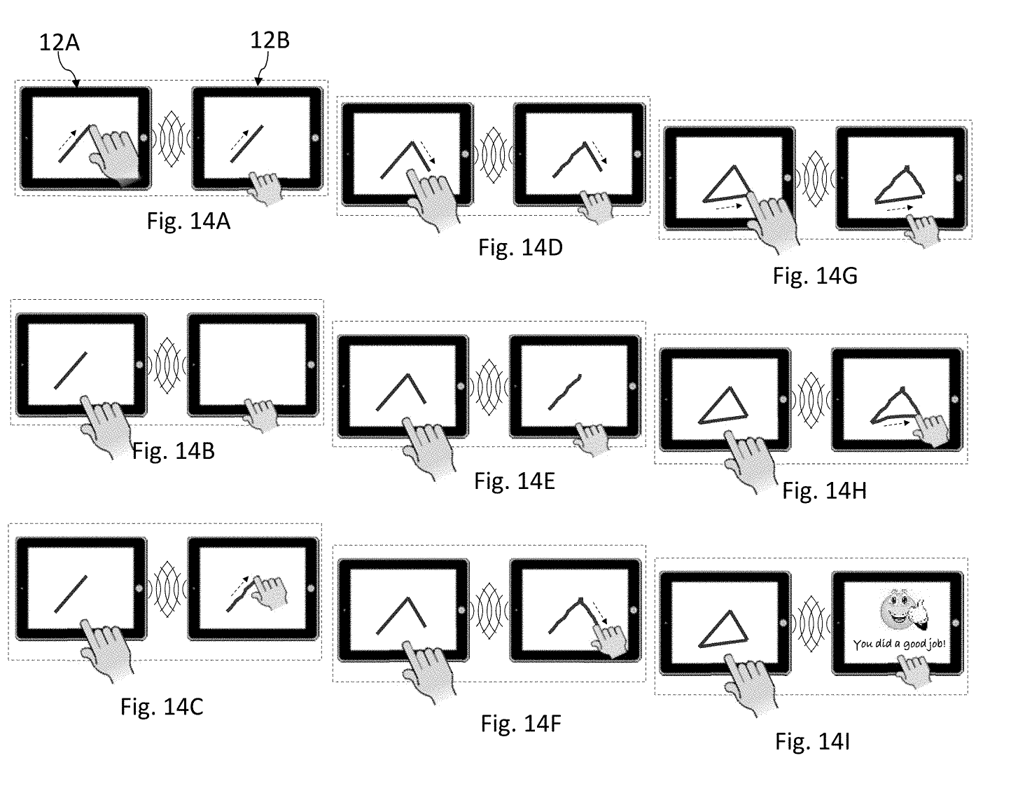

FIGS. 14A through 14I illustrate a method of learning drawing graphic figures, which is constructed in accordance with some embodiments of the method 30 in FIG. 4. Each figure illustrates both the first screen device 12A and the second touch screen device 12B. As one example, the first user associated with the first touch screen device is a parent (or a teacher) and the second user associated with the second touch screen device is a child (or a student). The figure to be learned is a triangle and includes three portions (three lines in this example). The method illustrates one example or an alternative of the method 30 in a segmenting mode. However, the decomposition of the first input does not occur after the entering of the first input, such as illustrated in the present example.

In FIG. 14A, the first line is drawn by the first user in the first touch screen device 12A and it is sent to and displayed on the second touch screen device 12B for the display time Td. In FIG. 14B, the first line is disappeared from the second device 12B. In FIG. 14C, the second user enters the first line in the second device. The forbidden gap time Tf and/or the second drawing time Tr2 are defined and applied in the present embodiments.

In FIG. 14D, the second line is drawn by the first user in the first touch screen device 12A and it is sent to and displayed on the second touch screen device 12B for the display time Td. In FIG. 14E, the second line is disappeared from the second touch screen device 12B. In FIG. 14F, the second user enters the second line in the second touch screen device. The forbidden gap time Tf and/or the second drawing time Tr2 are defined and applied in the present embodiments.

In FIG. 14G, the third line is drawn by the first user in the first touch screen device 12A and it is sent to and displayed on the second touch screen device 12B for the display time Td. Thereafter, the third line is disappeared from the second device 12B. In FIG. 10H, the second user enters the third line in the second device. The forbidden gap time Tf and/or the drawing time Tr are defined and applied in the present embodiments. In FIG. 10I, the second input (including all portions) is evaluated and the final result based on the evaluation is displayed on the second device. The method in FIGS. 14A-14I may be implemented in a single device, such as described by the method 88 of FIG. 12.

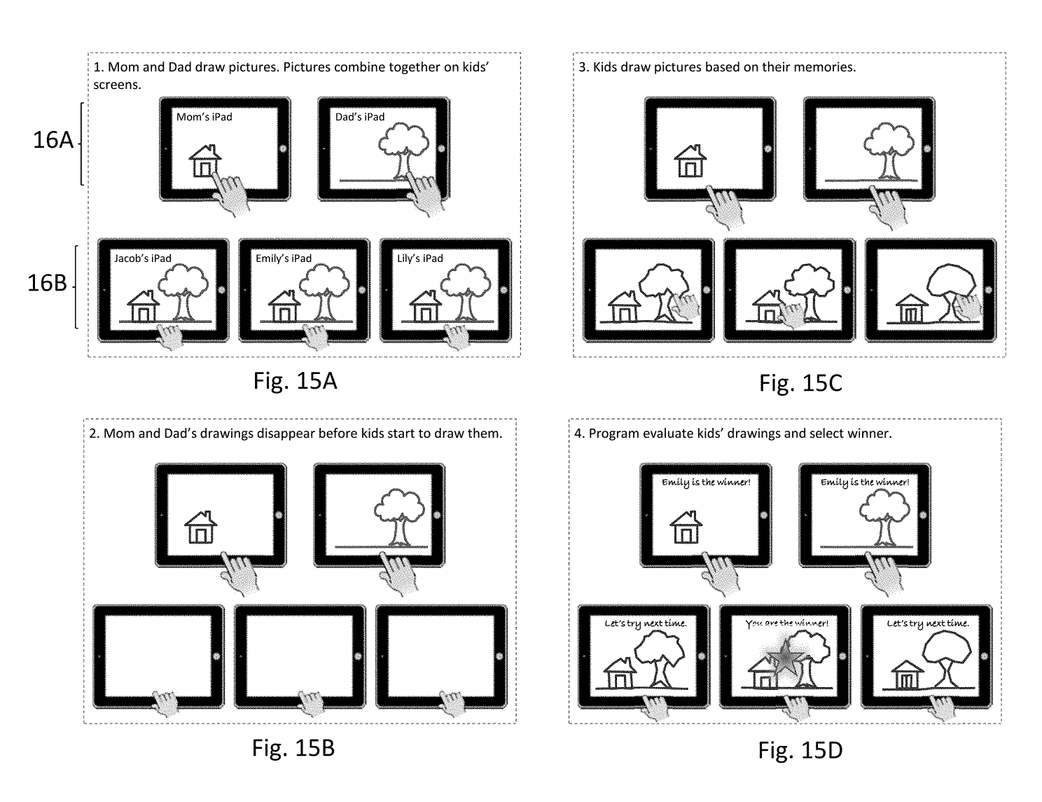

FIGS. 15A through 15D illustrate a method of learning drawing graphic figures, which is constructed in accordance with some embodiments of the method 30 in FIG. 4. In the present embodiments, multiple touch screen devices (as illustrated in FIG. 2) and multiple users are involved. The touch screen devices include the first group of touch screen devices 16A and the second group of touch screen devices 16B. Correspondingly, the first group of users (such as dad and mom) and second group of users (such as three kids) are associated with the two groups of touch screen devices. The method provides a learning process through completion among the second users (kids).

In FIG. 15A, the first users (parents) draw pictures (such as a house and a tree) on respective first touch screen devices 16A. The pictures are combined to the first hand drawn figure (a house and a tree in the present example), which is sent to and displayed on the second touch screen devices 16B for a fixed period of time, defined in the display time Td.

In FIG. 15B, after the display time Td, the first hand drawn figure disappears from the second touch screen devices 16B.

In FIG. 15C, the second users (kids) enter the second hand drawn figures on the second touch screen devices 16B. The forbidden gap time Tf and/or the drawing time Tr are defined and applied in the present embodiments

In FIG. 15D, the second hand drawn figures are evaluated (compared and correlated) to determine one of the second users with highest score as the winner. The method is not only for learning and may also be used for competition or game.

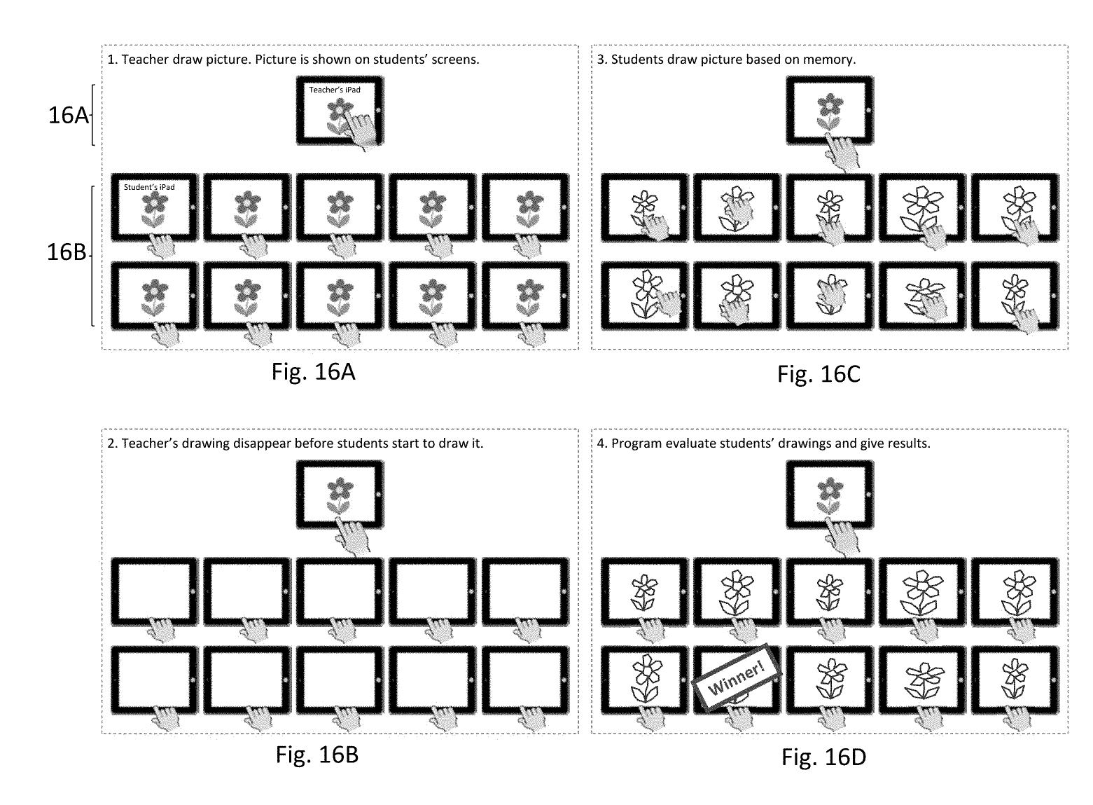

FIGS. 16A through 16D are schematic views of a method of learning drawing graphic figures in accordance of some embodiments. In the present embodiments, multiple touch screen devices (as illustrated in FIG. 2) and multiple users are involved. The touch screen devices include the first group of touch screen devices 16A (only one in the present example) and the second group of touch screen devices 16B (ten in the present example). Accordingly, the number of the first users is only one (such as a teacher) and the number of the second users is more than one (such as 10 students). The method provides a learning process through completion among the second users (students).

In FIG. 16A, the first user (teacher) draws the first input (a hand drawn figure, such as a flower in the present embodiment) on the first touch screen devices 16A. The first input is sent to and displayed on the second touch screen devices 16B for a period of time, defined by the display time Td.

In FIG. 16B, after the display time Td, the first input disappears from the second touch screen devices 16B.

In FIG. 16C, the second users (students) enter the second input (hand drawn figures in the present embodiment) on the second touch screen devices 16B after the first input disappears or additionally after the forbidden gap time Tf. The entering of the second input may be constrained within the second drawing time Tr2. The forbidden gap time Tf and/or the second drawing time Tr2 are defined and applied in the present embodiments.

In FIG. 16D, the second input is evaluated (compared and correlated) to determine one of the second users with highest score as the winner.

The disclosed method has various alternatives. In some embodiments, the method 30 involves only one player. In this case, the method proceeds between the player and a virtual player. The virtual player provides the first hand drawn figure from a database having a plurality of saved figures that includes symbols, drawings texts, or a combination thereof.

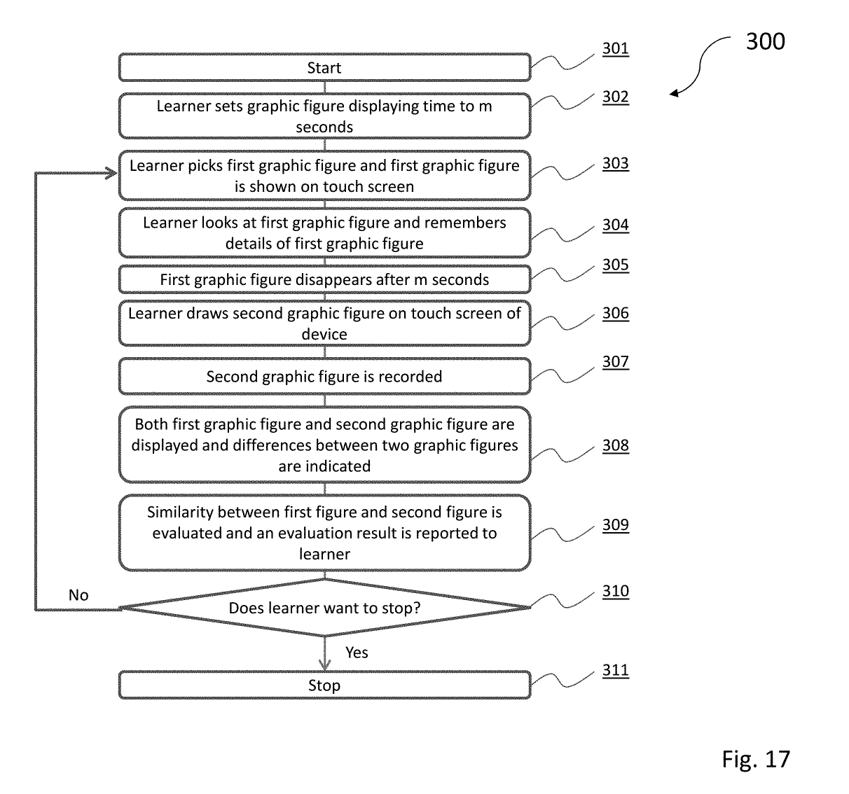

FIG. 17 is a flowchart of the exemplary method 300 of the method of learning drawing graphic figures. When the learning process is started (301), the method 300 includes an operation 302, in which the time period of the first graphic figure being shown on the screen is preset as a fixed period of time Td. In operation 303, a first graphic figure, picked by a learner from a database in a touch screen device for example, is displayed on the screen of the touch screen device. In operation 304, the learner looks at the first graphic figure and tries to remember the contents of the first figure. In operation 305, the first graphic figure disappears after the time period set at the beginning of the process. In operation 306, after the first graphic figure disappears the learner tries to re-draw the first graphic figure by drawing a second graphic figure on the screen of the touch screen device. In operation 307, the second graphic figure is recorded. In operation 308, then both the first graphic figure and the second graphic figure are displayed and differences between the two figures are indicated. In operation 309, a similarity between the first graphic figure and the second graphic figure is evaluated and an evaluation result is reported to the learner, helping the learner to learn the differences between the first figure and the second figure the learner has just drawn. In operation 310, after that the program checks if the player wants to stop the process of learning drawing graphic figures. If the answer is “No”, the process goes back to operation 303. If the answer is “Yes”, the method 300 is stopped at 311.

It is not necessary that the first graphic figure is picked only from the database in the touch screen device. As illustrated in FIG. 11, the touch screen device is able to receive the first graphic figure from a remote memory device 84 with a database via a communication network 14.

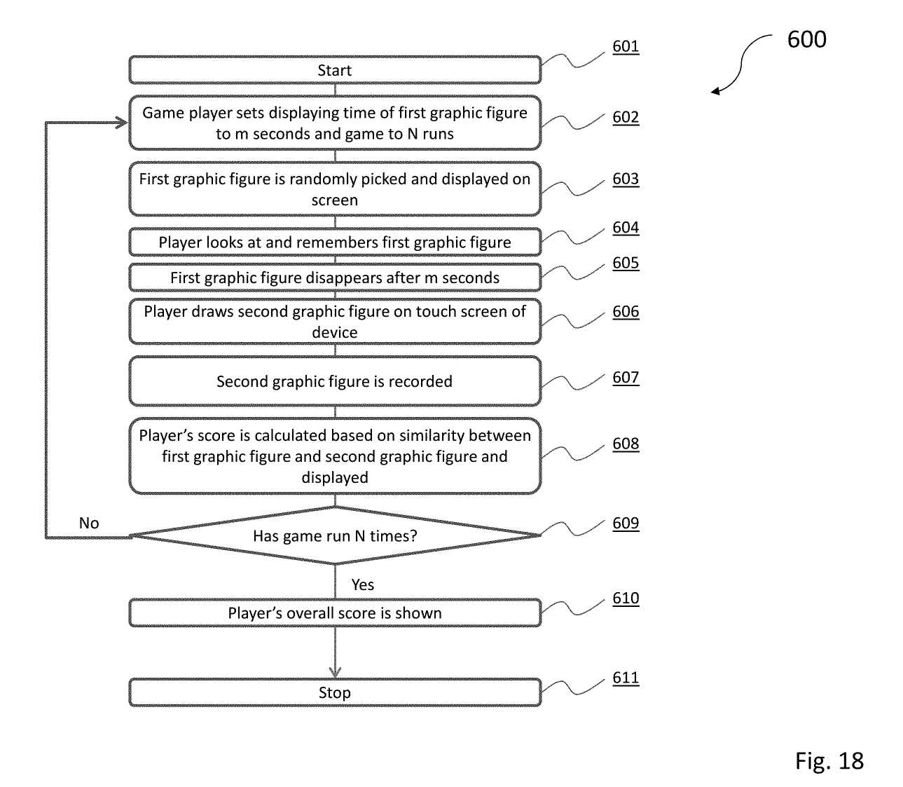

FIG. 18 is a flowchart of an exemplary game method 600. The method 600 is executed by a program in a touch screen device. When a game is started (601), various time parameters are set. For example, in operation 602, the display time Td is set and the number of runs of the game is set as well. In operation 603, a first graphic figure is displayed on the screen of the touch screen device. In operation 604, a player looks at the first graphic figure and tries to remember the contents of the first graphic figure during the display time Td. The first graphic figure disappears after the display time Td (605). In operation 606, after the first graphic figure disappears the player tries to imitate the first graphic figure by drawing a second graphic figure on the touch screen device. In operation 607, the second graphic figure is recorded. In operation 608, a similarity between the first graphic figure and the second graphic figure is evaluated and a score is calculated based on the similarity for the player. At operation 609, the program checks if the game has repeated the number of runs set at the beginning of the game. If the answer is “No”, the process goes back to operation 603 and repeats another run. If the answer is “Yes”, then the method 600 proceeds to operation 610, in which the player's overall score is calculated and displayed. Then the method 600 is ended (611). Again, it is not necessary that the first graphic figure is picked from the database of the touch screen device. The touch screen device is able to receive the first graphic figure from a remote memory device with a database via a communication network.

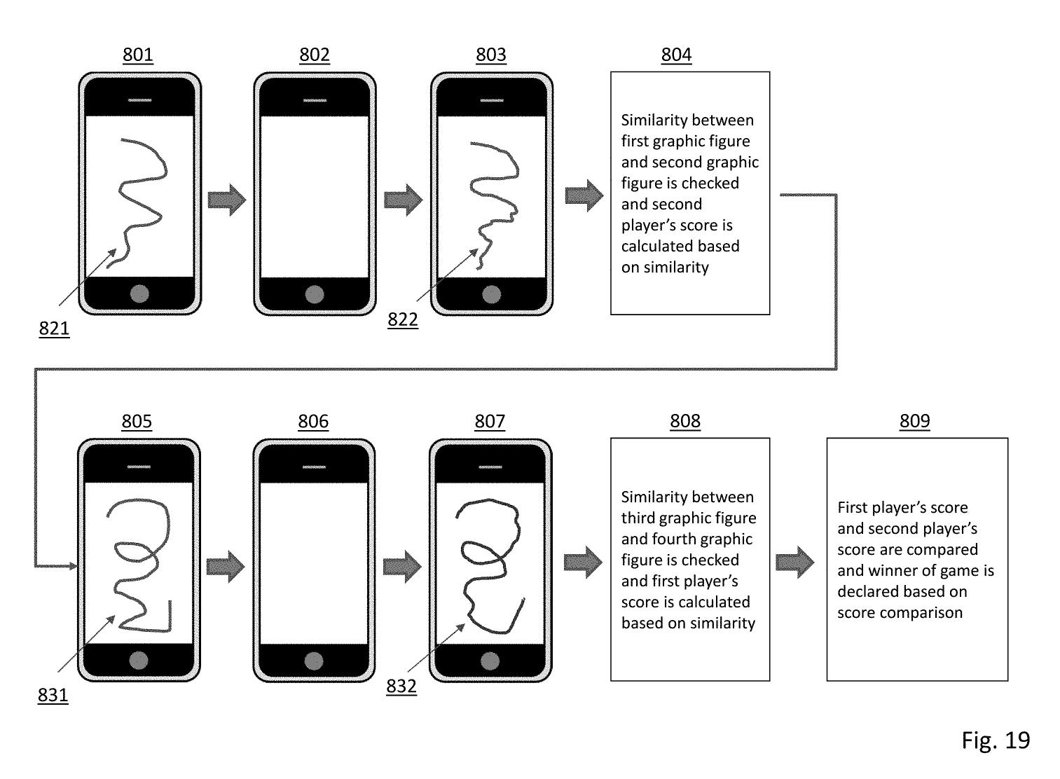

FIG. 19 shows an exemplary embodiment of this invention's application to entertainment—a gaming method involving two or more players. When the game starts a first graphic FIG. 821 is drawn by a first player on a touch screen of a device (801). A second player looks at the first graphic figure and remembers the contents of the first graphic figure. The first graphic FIG. 821 disappears after a period of time which can be set before the beginning of the game (802). After the first graphic figure disappears the second player draws a second graphic FIG. 822 on a touch screen of a device (803). The second player tries to repeat the first figure and make the second FIG. 822 to be as similar to the first graphic FIG. 821 as possible. Both the first graphic figure and the second graphic figure are recorded. A similarity between the first figure and the second figure is evaluated and a first score based on the result of the evaluation is calculated for the second player (804). Then the roles of the first player and the second player are exchanged. A third graphic FIG. 831 is drawn by a second player on a touch screen of a device (805). The first player looks at the third graphic figure and remembers the contents of the third graphic figure. The third graphic FIG. 831 disappears after a period of time which can be set before the beginning of the game (806). After the third graphic figure disappears the first player draws a fourth graphic FIG. 832 on a touch screen of a device (807). The first player tries to repeat the third figure and make the fourth FIG. 832 to be as similar to the third graphic FIG. 831 as possible. Both the third graphic figure and the fourth graphic figure are recorded. A similarity between the third figure and the fourth figure is evaluated and a second score based on the result of the evaluation is calculated for the first player. The game may continue to have as many runs as the players want. At the end of the game the person who has an overall higher score is declared as the winner of the game.

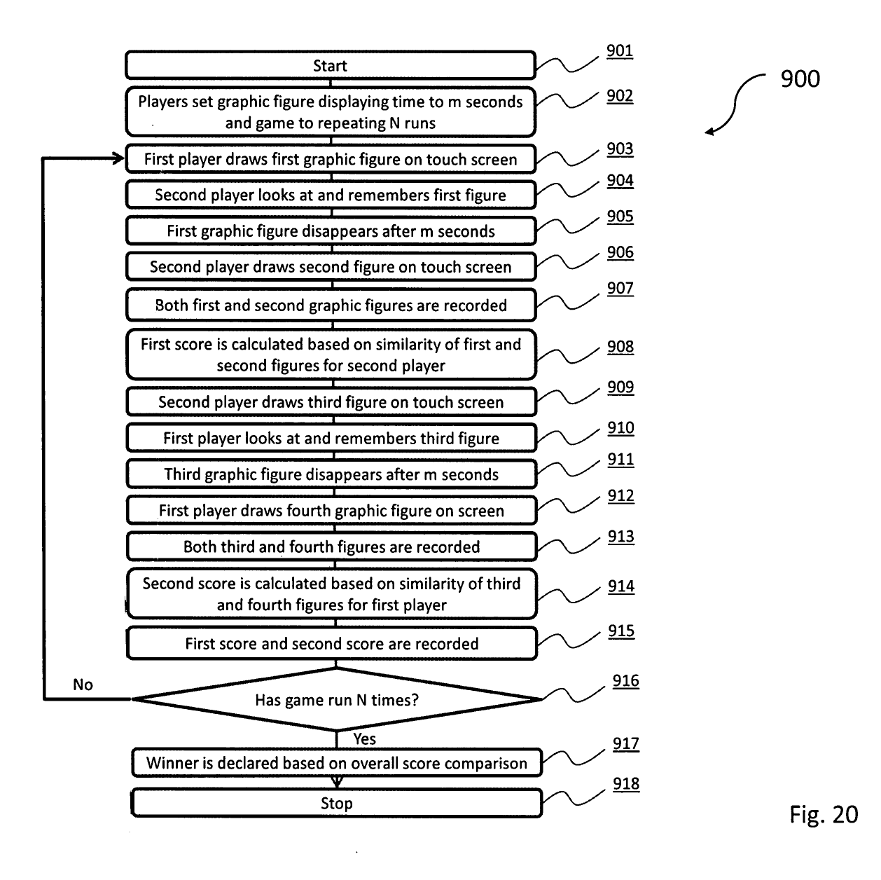

FIG. 20 is a flowchart of the exemplary gaming method 900. When a game is started (901), a time period of displaying a first graphic figure and a third graphic figure on a screen is set and a number of runs of a game is set as well (902). A first player draws a first graphic figure on a touch screen (903). A second player watches the first graphic figure and memorizes the contents of the first FIG. 904). The first graphic figure disappears after the time period set at the beginning of the game (905). After the first graphic figure disappears the second player tries to re-draw the first graphic figure, which has been just drawn by the first player, by drawing a second graphic figure on a touch screen of a device (906). Both the first graphic figure and the second graphic figure are recorded (907). The second player's score is calculated based on similarity between the first figure and the second FIG. 908). Then the first player and the second player switch their roles. The second player draws a third graphic figure on a screen of a device (909). The first player looks at the third graphic figure and remembers the contents of the third graphic FIG. 910). The third figure disappears after the period of time set at the beginning of the game (911). After the third figure disappears, the first player tries to re-draw the third figure by drawing a fourth graphic figure on a touch screen of a device (912). Both the third figure and the fourth figure are recorded (913). The first player's score is calculated based on similarity between the third figure and the fourth FIG. 914). The first player's score and the second player's score are recorded (915). The game program checks if the game has repeated the number of runs set at the beginning of the game (916). If the answer is “No”, the game goes back to step 903 and repeats another run. If the answer is “Yes”, a winner of the game is declared based on an overall score comparison between the first player and the second player (917). Then the game stops (918). It is not necessary the two players draw the first graphic figure, the second graphic figure, the third graphic figure, and the fourth graphic figure on the same device with a touch screen. The first player and the second player can use different devices, such as 12A and 12B in FIG. 1. The first device 12A and second device 12B are connected via a communication network 14.

The score of the first player is not necessarily proportional to the similarity of the third graphic figure and the fourth graphic figure and the score of the second player is not necessary proportional to the similarity of the first graphic figure and the second graphic figure. For example, the first player's score can be calculated not only based on similarity between the third figure and the fourth figure, but also based on the complexity of the third graphic figure. The second figure with high similarity to a simple first figure may have same score as a second figure with low similarity to a complex first figure. In this way the second player may strategize how complicated his drawing could be to lower the first player's score. The same principle is applied to the second player's score as well.

In previous embodiments, each of the first and second inputs is a hand drawn figure, such as a picture, a symbol or a text. The disclosed method and system provide an approach to enhance learning and gaming. However, the scope of the method and system is not limited to the hand drawn inputs and touch screen device(s), it can be extended to other objects, such as voice, music, photo, video or other suitable objects. Accordingly, the devices 12A and 12B may not necessarily be touch screen devices, and may be other suitable devices capable of receiving, entering and other processing to the corresponding objects, such as voice, music, photo or video. Various time parameters are still applicable but represent corresponding time parameters associated with the respective object. For example, the display time Td is still applicable but represents the time to play a voice data, play a piece of music, play a video or display a photo. Various first and second drawing times (Tr1 and Tr2), represent the first and second entering times that are the time to enter the respective objects, such as taking a photo, giving a speech (a voice data), playing a piece of music or playing a video.

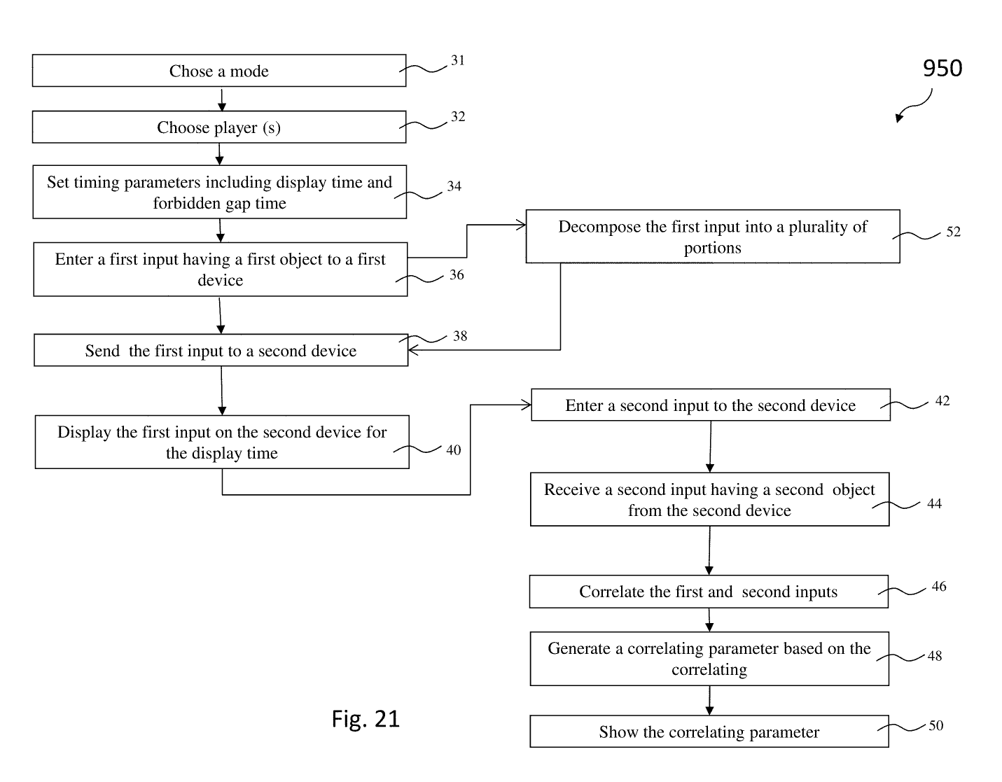

FIG. 21 is a flowchart of a method 950 constructed according to aspects of the present disclosure in one or more embodiments. The method 950 is implementable in a system 10 of FIG. 1 or FIG. 2. As noted above, the devices 12A and 12B are devices capable of receiving, entering and processing respective object, such as figure, text, voice, music, photo or video. In some embodiments, the device 12 (12A or 12B) is a touch screen device, such as a touch screen smart phone, touch screen tablet, touch screen desktop or other suitable touch screen device. In other embodiments, the device 12 may be other suitable device capable of receiving, entering and processing respective object, such as figure, text, voice, music, photo or video.

Particularly, the device 12 is further illustrated in FIG. 3. In some embodiments, the touch screen 22 may be replaced by other suitable module, such as a recording module to record a piece of music or speech or a keyboard (or a virtual keyboard) to play a piece of music. The display module 26 may be replaced by other suitable module, such as a play module to play a piece of music or speech. The method 950 provides a method for learning or competing through other objects. For example, oral translation skill can be practiced in the system 10 and the method 950.

The method 950 may begin at an operation 31 by choosing a play mode. The operation 31 is executed by a first user using the first device 12A. In some embodiments, the modes include a learning mode and a completion mode. For example, in the learning mode, the first user may play as a tutor, one of tutors, a student or one of students. In another example, in the learning mode, the method 950 is designed for learning to play music, speak, take a photo, make a video, draw a figure or translate (from one object to another object). In another example, the competition mode includes two or more players compete with each other. The modes to choose from may include other modes, such as team competition (a group to a group); or a class (a teacher to a plurality of students).

In some embodiments, the operation 31 may further include choosing an object, such as figure, voice, music, photo or video. In some embodiments, the operation 31 may alternatively include choosing a play mode, in which the method includes converting one type of object to another type of object, such as translating from a speech in one language to a speech in another language; interpreting a piece of music by an oral speech; singing a song according to a piece of music; and so on.

The method 950 may include an operation 32 by choosing another player or other players according to the determined play mode. For example, when a class mode is chosen, a list of students in the class may be shown on the display screen of the first device 12A for the first user to choose from. In another example, the first user directly enters a second player to the touch screen, in the competition mode.

The method 950 includes an operation 34 to initiate various settings that include setting a display time (that means the time to display or play, depending on the respective object) and a forbidden gap time. In various embodiments, the parameters set by the operation 34 may include display time Td, forbidden gap time Tf, first entering time Tr1, second drawing time Tr2, or a combination thereof. In the present embodiment, the display time, entering times and forbidden gap time are set to be fixed period of times, respectively. In other embodiments, those timing parameters may be reset after each learning (competition) cycle in the method 950.

In some embodiments, the setting operation 34 is performed by a first user who uses the first device 12A. In some other embodiments, the operation 34 is achieved by multiple users through a setting procedure. In the setting procedure, the multiple users input respective values of a parameter through respective devices; and then those values are combined (such as by averaging) to determine the final value of that parameter. In a particular example, the setting is jointly implemented by the first user and the second user. For example, the first and second users each pick a values, the method 950 automatically (by algorithm) chose a value most close to both picked values, such as with least variation.

In some embodiments, various settings in the operation 34 are automatically (by algorithm) determined by the system 10 or a component thereof, such as the first device 12A. In some embodiments, the timing parameters are determined according to other parameters, such as difficult level, user level, previous ranking/score, application characteristics, or a combination thereof.

In some embodiments, the operation 34 includes choosing a difficult level (such as selecting one from a list of multiple difficult levels) by the first user, and one or more timing parameter (such as display time) is determined according to the chosen difficult level. For example, when the difficult level is higher, the display time is determined to be shorter to match the challenge of the chosen difficult level. In furtherance of the embodiments, the display time is automatically determined from a lookup table that pairs display times and difficult levels. The lookup table may be saved in a database, such as the database of the system 10 or the database of the device 12A. In this case, the method system 10 automatically sets the display time according to the corresponding difficult level by searching the lookup table.

In some embodiments, the system 10 automatically choses a display time according to the rankings (higher ranking, shorter display time for increased challenge level corresponding to the ranking in one example) or previous score of a player (higher score, shorter display time in another example).

In yet other embodiments, various parameters are determined through a combination of the above mentioned mechanisms. For example, a first subset of parameters is determined by a first mechanism (such as difficult level) and a second subset of parameters is determined by a second mechanism (such as ranking).

In yet other embodiments, various parameters are determined dynamically, such as resetting in each cycle. For example, at the beginning of a first cycle, a time parameter is determined to a first value according to the ranking at that time, and at the beginning of a second cycle, is determined to a second value according to the new ranking at that time. In another example, a time parameter, at the beginning of a first cycle, is determined to a first value according in a first mechanism (such as difficult level), and at the beginning of a second cycle, is determined to a second value by a second mechanism (such as ranking).

In some other embodiments, a time parameter is determined according multiple other parameters. For example, the display time is determined by the chosen difficult level and the complexity of the input (the first input or the second input, which will be described later). Thus, the display time is related to the difficult level and the complexity of the input. The complexity is evaluated by the system based on the input. For example, when the first input is more complicated, the display duration is longer. When the second input is simple, the display duration is shorter.

In some embodiments, various time parameters are correlated and are determined according to each another. For example, the forbidden gap time is related to the display time, the difficult level, or both. In furtherance of the example, the forbidden gap time equals to or is proportional to the display time. In some other example, the forbidden gap time is independently set by the first user, the second user or both in a way similar to set the display time. In the present embodiment, various time parameters are maintained and managed by a timing module of the system 10.

In some embodiments, the operation 34 includes setting other parameters, such as the number of rounds (each round includes two cycles: the first player challenges the second player in the first cycle and the second player challenges the first player in the second cycle) that indicates how many rounds will be played. Other setting may include sound on/off, hint on/off, and/or fragmenting (decomposition: the first input is decomposed into multiple fragments to reduce the difficult) on/off. Sound effect may provide background music, for example. The hint function may provide on-screen help.

The method 950 includes an operation 36 to enter a first input that has an object (voice, music, photo or video) to the first device (such as 12A). In the present embodiment, the operation 36 is implemented after the operations 31, 32 and 34. Again, the first device may be a plurality of devices, such as the touch screen devices 16A illustrated in FIG. 2. For easy understanding, it is collectively referred to as the first device 12A in the following description. The entering of the first input is performed by a first user. In some embodiments, a first entering time is defined, such as by the operation 34, as a fixed period of time. The entering of the first input is only available during the first entering time Tr1. After the end of the first entering time Tr1, the entering of the first input is not accepted by the system 10, which provides one way to challenge the first user. In one example, the first entering action triggers the first entering time to tick.

The method 950 includes an operation 38 to send the first input from the screen device 12A to the screen device 12B through the data communication network 14. In some embodiments, the second device may be a plurality of devices, such as the devices 16A illustrated in FIG. 2. The operation 38 may be triggered by pressing a button of the first device 12A, touching a symbol on the touch screen of the first device 12, starting to enter the first input (such as starting to play a piece of music, starting to speak) or other proper action applicable to the first device 12A. In the present embodiment, the operation 38 is executed by the first user.

The method 950 includes an operation 40 to display (or play) the first input on the second device 12B for a period of time defined as the display time Td. As noted above, the display time is a fixed period of time in the present embodiment. After the display time, the system 10 stops displaying (or playing) the first input. The first input disappears from the display screen of the second device 12B or stops to play from the second device 12B.

The method 950 includes an operation 42 to enter a second input to the second device (such as 12B). The second input is another object similar to the first object or different from the first object. For example, the first input is a piece of music and the second input is another piece of music. In another example, the first input is a piece of music and the second input is a speech. The entering of the second input is performed by a second user.

Once the first input is received by the second device 12B, the first input is displayed by the second device 12B for a predefined duration (such as n second, where n is any proper value), which is defined by the display time. The second user enters the second input based on the first input and sends the second input to the first device 12A through the data communication network 14. However, the entering of the second input is acceptable by the second device 12B only after the forbidden gap time. After the first input disappears from the second touch screen 12B, there is a period of time. During that period of time, the second touch screen device 12B does not accept the entering of the second input. This period of time is defined by the forbidden gap time. The forbidden gap time is designed to exercise the memorization strength of the corresponding user (the second user at present step). Furthermore, the entering of the second input may further be limited to be completed during another period of time, which is defined by the second entering time Tr2. As described above, the forbidden gap time and the second entering time are time parameters defined by the operation 34.

In one embodiment, the second input is a mimic of the first input. For example, if the first input is a speech, the second input is another speech by the second user to mimic the first input. In another embodiment, the second input is an input that is related to the object figure of the first input. For example, if the first input is a speech in a first language, the second input is a speech in a second language) that translates the meaning of the first input.

The method 950 includes an operation 44 to receive the second input by the first device 12A from the second touch screen device 12B through the data communication network 14. The operation 44 may be triggered by the second user who is accessing the second device 12B, after the completion of the operation 42.

The method 950 includes an operation 46 by correlating the first input and the second input. The correlating may be implemented by the data processing module 24 of the first device 12. In various embodiments, the correlating process may include object processing (such as mapping); relating (such as relating a word to a piece of music); translating (such as translating a speech in one language to a speech in another language); or a combinations thereof.

The method 950 also includes an operation 48 by generating a correlation parameter based on the results of the correlating process. In some embodiments, the correlation parameter represents the similarity or relationship between the second and the first inputs. In some embodiments, the correlation parameter represents the accuracy between the second and the first inputs (such as in translating from a language to a different language, from music to photo, or from music to speech). For examples, the correlation parameter is a score that may be in a numerical scale (such as 0-100) or word scale (such as “excellent”, “good”, “above the average”, and so on). In other embodiments, the correlation parameter may additionally or alternatively include a message (such as “well done”) associated with the comparing result.

In some other embodiments, the correlation parameter is a weighted parameter associated with one or more weighting factor, such as the difficult level and/or the complexity of the first input. For example, the final numerical score generated from the correlating process is further adjusted according to the difficult level.

The method 950 may also include an operation to send the correlation parameter from the first device 12 to the second device 14. In an alternative embodiment, the operations 46 and 48 are implemented in the second device 12B. In this case, the operation 44 may be eliminated. Instead, the method 30 includes another operation to receive the correlation parameter by the first device 12A from the second device 12B after the operations 46 and 48.

The method 30 also includes an operation 50 to display (or voice) the correlation parameter. In the present embodiment, the correlation parameter is displayed in the display module of the first device 12A and in the display module of the second device 12B as well. In some other embodiments, the correlation parameter is saved for later use, such as being used to determine the final result when the method is a competition mode or being used to track the progress made by one player.

In the competition mode, the method 950 goes back to the operation 36 to repeat the all operations in a second cycle. However, the first and second users swap their roles in the second cycle. This will complete one round. The method 30 may repeat many rounds, which is defined as the number of rounds at the operation 32. The operation 50 may alternatively or additionally display the final scores to each player after the completion of the all rounds based on an average of scores from the all rounds.

In other embodiments, as illustrated in FIG. 4, the method 950 includes an operation 52 to decompose the first input into a plurality of portions (or segments if the first input is a piece of music or a speech) to reduce the learning difficult for a beginner. The decomposing in the operation 52 may be implemented by the data processing module 20 before the operation 40 to display the first input. The second user only enters each portion each time and that portion may be processed in various ways in different modes, which is further described below. In a particular example, each portion is displayed (or played), disappeared (or stopped), and the entered an object corresponding to the portion is treated as a second input through the operations (such as operations 40, 42, 44, 46, 48 or a subset there) of the method 950. In one mode, the operations 46-50 are applied to the whole second hand input after the completion of entering each and every portion.

The present disclosure provides a method that includes displaying a first input for a period of display time Td on a touch screen device; accepting to enter a second input by the touch screen device after the first graphic figure disappears and a forbidden gap time Tf; evaluating the first and second inputs to determine a correlation parameter between the first and second inputs; and displaying a result associated with the correlation parameter on the touch screen device.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method, comprising:
displaying a first graphic figure for a period of display time Td on a first touch screen device;
accepting to enter a second graphic figure by the first touch screen device after the first graphic figure disappears and a forbidden gap time Tf;
evaluating the first and second graphic figures to determine a correlation parameter between the first and second graphic figures; and
displaying a result associated with the correlation parameter on the first touch screen device.

2. The method of claim 1, further comprising setting the period of display time Td before the displaying of the first graphic figure.

3. The method of claim 1, further comprising setting the forbidden gap time Tf before the displaying of the first graphic figure.

4. The method of claim 1, further comprising setting a first drawing time before the displaying of the first graphic figure, wherein the accepting to enter the second graphic figure further includes stopping to accept after the first drawing time.

5. The method of claim 4, further comprising:
setting a second drawing time; and
entering the first graphic figure during the second drawing time before displaying of the first graphic figure, wherein entering of the first graphic figure further includes stopping to accept the entering of the first graphic figure after the second drawing time.

6. The method of claim 1, further comprising setting a difficult level.

7. The method of claim 6, wherein the display time Td and the forbidden gap time Tf are determined according to the difficult level.

8. The method of claim 6, wherein the display time Td and the forbidden gap time Tf are determined according to a collective index associating with the difficult level and a complexity level of the first graphic figure.

9. The method of claim 8, wherein
the display time Td is determined to increase when the collective index is increased; and
the forbidden gap time Tf is determined to decrease when the collective index is increased.

10. The method of claim 9, further comprising decomposing the first graphic figure into a plurality of portions.

11. The method of claim 10, wherein the displaying the first graphic figure includes displaying one of the plurality of portions in the first graphic figure.

12. The method of claim 11, wherein
the collective index is determined to one portion of the plurality of portions in the first graphic figure; and
the display time Td and the forbidden gap time Tf corresponding to the one portion of the plurality of portions in the first graphic figure are determined according to the collective index associated with the one portion of the plurality of portions in the first graphic figure.

13. The method of claim 1, wherein
the first graphic figure is a first text in a first language and the second graphic figure is a second text in a second language; and
the evaluating of the first and second graphic figures includes translating the first text into a third text in the second language and comparing between the second third texts.

14. The method of claim 1, further comprising receiving the first graphic figure from a second touch screen device coupled to the first touch screen device through one of Internet, intranet, wireless relay connection, WiFi, Bluetooth and cable.

15. The method of claim 1, further comprising
receiving respective figures from a plurality of second touch screen devices, respectively; and
combining the respective figures to form the first graphic figure, wherein the plurality of second touch screen devices are coupled to the first touch screen device.

16. The method of claim 1, further comprising receiving the first graphic figure from a database having a plurality of predefined figures.

17. A method, comprising:
setting a forbidden gap time Tf;
displaying a first input for a period of display time Td on a device;
accepting to enter a second input by the device after the first input disappears and the forbidden gap time Tf;
evaluating the first and second inputs to determine a correlation parameter between the first and second inputs; and
showing a result associated with the correlation parameter on the device.

18. The method of claim 17, wherein the one of the first input and the second input is selected from the group consisting of figure, text, voice, music, photo, and video.

19. A hand-drawn figure system operable on a touch screen device, comprising:
a transmission module operable to receive a first graphic figure from another mobile device through a data transmission network;
a display component operable to display the first graphic figure for a predefined period of display time Td;
a touch screen operable to receive a second graphic figure after the first graphic figure disappears and a forbidden gap time Tf;
a timing module operable to manage the predefined period of display time Td and the predefined fixed display forbidden gap time Tf; and
a data processing module designed to evaluate the first graphic figure and the second graphic figure to determined a difference between the first and second graphic figures.

20. The system of claim 19, wherein
timing module is operable to manage a predefined period of drawing time; and
the touch screen is operable to receive the second graphic figure only during the predefined period of drawing time.
